(19) United States
(12) Patent Application Publication
(10) Pub. No.: US 2011/0317839 A1
(43) Pub. Date: Dec. 29, 2011

(54) INFORMATION PROCESSING DEVICE AND METHOD, PROGRAM, AND INFORMATION PROCESSING SYSTEM

(75) Inventor: Yoshihiro Yoneda, Tokyo (JP)

(73) Assignee: SONY CORPORATION, Tokyo (JP)

(21) Appl. No.: 13/161,688

(22) Filed: Jun. 16, 2011

(30) Foreign Application Priority Data
Jun. 24, 2010 (JP) P2010-143399

(51) Int. Cl. H04W 12/04

(52) U.S. Cl. 380/270

(57) ABSTRACT

An information processing device which shares data with one or more communication partners includes a creation unit which creates its own encryption key that the device uses for itself and encryption keys that the communication partners use, a first communication unit which transmits all the encryption keys created by the creation unit to the communication partners with the first communication, a division unit which divides the data, an encryption unit which encrypts its own data that the device is to save for itself among the data divided by the division unit with its own encryption key, a second communication unit which transmits other data that the communication partners are to save among the data divided by the division unit to the communication partners with the second communication, and a storage unit which stores its own data encrypted by the encryption unit and the other encryption keys.

### BACKGROUND

The present disclosure relates to an information processing device and method, a program, and an information processing system, and particularly to an information processing device and method, a program, and an information processing system that are designed to save data more conveniently and safely.

In the related art, an information processing device has been suggested that is designed to share data with other devices by means of handover from a first communication to a second communication in order to simplify a process such as authentication, or communication setting when three or more mobile telephones are to share information with one another by performing wireless communication (refer to Japanese Unexamined Patent Application Publication No. 2010-73105).

In addition, generally, one file is shared between a plurality of devices by providing a shared server, a file server, or the like in a network connected with the plurality of devices such as a LAN (Local Area Network).

In a network such as a LAN, it is possible to avoid information leakage, for example, such that a user who uses a device connected to the network is prevented from copying files to a recording medium and making off with them, by setting security levels for the shared files.

### SUMMARY

However, there is a concern that data or information exchanged by wireless communication performed between mobile telephones is easily leaked by users of the mobile telephones.

The present technology takes the above circumstance into consideration, and particularly, it is desirable to save data more conveniently and safely.

According to an embodiment of the present technology, there is provided an information processing device sharing data with one or more communication partners which includes a creation unit which creates its own encryption key that the device uses for itself and encryption keys that the communication partners use, a first communication unit which transmits all the encryption keys created by the creation unit to the communication partners with the first communication, a division unit which divides the data, an encryption unit which encrypts its own data that the device is to save for itself among the data divided by the division unit with its own encryption key, a second communication unit which transmits other data that the communication partners are to save among the data divided by the division unit to the communication partners with the second communication, and a storage unit which stores its own data encrypted by the encryption unit and the other encryption keys.

The encryption unit may be caused to erase its own encryption key used in the encryption after its own data is encrypted.

The first communication unit may be caused to receive its own encryption key that is stored by the communication partners and transmitted through the first communication, and the second communication unit may be caused to receive the other data saved by the communication partners and transmitted through the second communication, and the information processing device can be further provided with a decryption unit which decrypts its own data stored in the storage unit with its own encryption key received by the first communication unit, and a restoration unit which restores the data from its own data decrypted by the decryption unit and the other data received by the second communication unit.

The storage unit may be caused to further store management information regarding the device itself and the communication partners sharing the data, and based on the management information, the division unit may be caused to divide the data, the second communication unit may be caused to transmit the other data to the communication partners, and the encryption unit may be caused to encrypt its own data.

According to an embodiment of the technology, there is provided an information processing method of an information processing device sharing data with one or more communication partners which includes creating its own encryption key that the device uses for itself and encryption keys that the communication partners use, first communicating which transmits all the encryption keys created by the creation process to the communication partners with the first communication, dividing the data, encrypting its own data that the device is supposed to save for itself among the data divided by the division process with its own encryption key, second-communicating which transmits other data that the communication partners are supposed to save among the data divided by the division process to the communication partners with the second communication, and storing its own data encrypted by the encryption process and the other encryption keys.

According to an embodiment of the technology, there is provided a program which causes a computer to execute a process of an information processing device sharing data with one or more communication partners and includes creating its own encryption key that the device uses for itself and encryption keys that the communication partners use, first communication controlling for controlling transmission of all the encryption keys created by the creation process to the communication partners with the first communication, dividing the data, encrypting its own data that the device is supposed to save for itself among the data divided by the division process with its own encryption key, second communication controlling for controlling transmission of the other data that the communication partners are to save among the data divided by the division process to the communication partners with the second communication, and controlling storage of its own data encrypted by the encryption process and the other encryption keys.

According to the embodiment of the technology, its own encryption key that is an encryption key that the device uses for itself and other encryption keys that are encryption keys that the communication partners use are created, all the created encryption keys are transmitted to the communication partners with the first communication, the data is divided, the own data that is data that the device is supposed to save for itself out of the divided data is encrypted with the own encryption key, the other data that is data that the communication partners are to save out of the divided data is transmitted to the communication partners with the second communication, and the encrypted own data and the other encryption keys are stored.

According to another embodiment of the technology, there is provided an information processing device sharing data with a communication partner which includes a first communication unit which receives its own encryption key that is an encryption key that the device uses for itself and the other encryption key that is an encryption key that the communication partner uses which are transmitted from the communication partner with first communication, a second communication unit which receives own data that is data that the device is to save out of the data divided in the communication partner and transmitted from the communication partner with second communication, an encryption unit which encrypts its own data received by the second communication unit with its own encryption key received by the first communication unit, and a storage unit which stores its own data encrypted by the encryption unit and the other encryption key.

The encryption unit may be caused to erase its own encryption key used in the encryption after its own data is encrypted.

The first communication unit may be caused to receive its own encryption key stored by the communication partner and transmitted with the first communication, the information processing device is further provided with a decryption unit which decrypts its own data stored in the storage unit with its own encryption key received by the first communication unit, and the second communication unit may be caused to transmit its own data decrypted by the decryption unit to the communication partner with the second communication.

The storage unit may be caused to further store management information regarding the device itself and the communication partner sharing the data, and based on the management information, the second communication unit may be caused to receive its own data transmitted from the communication partner, and the encryption unit may be caused to encrypt its own data.

According to another embodiment of the technology, there is provided an information processing method of an information processing device sharing data with a communication partner which includes first-communicating to receive its own encryption key that is an encryption key that the device uses for itself and the other encryption key that is an encryption key that the communication partner uses which are transmitted from the communication partner with the first communication, second-communicating to receive own data that is data that the device is to save out of the data divided in the communication partner and transmitted from the communication partner with the second communication, encrypting its own data received in the second communication process with its own encryption key received in the first communication process, and storing its own data encrypted in the encryption process and the other encryption key.

According to another embodiment of the technology, there is provided a program which causes a computer to execute a process of an information processing device sharing data with a communication partner and includes first communication controlling for controlling a reception of its own encryption key that is an encryption key that the device uses for itself and the other encryption key that is an encryption key that the communication partner uses which are transmitted from the communication partner with the first communication, second communication controlling for controlling a reception of own data that is data that the device is to save out of the data divided by the communication partner and transmitted with the second communication, encrypting its own data received in the second communication control process with its own encryption key received in the first communication control process, and controlling storage of its own data encrypted in the encryption process and the other encryption key.

According to the embodiment, the own encryption key that is transmitted from the communication partner with the first communication and is an encryption key that the device uses for itself and the other encryption key that is an encryption key that the communication partner uses are received, the own data that is data that the device is to save for itself out of data divided by the communication partner and transmitted with the second communication is received, the received own data is encrypted with the received own encryption key, and the encrypted own data and the other encryption key are stored.

According to still another embodiment of the technology, there is provided an information processing system constituted by a first information processing device and one or more second information processing devices, in which the first information processing device includes a creation unit which creates a first encryption key that is an encryption key that the first information processing device uses and a second encryption key that is an encryption key that the second information device uses, a first communication unit which transmits all the encryption keys created by the creation unit to the second information processing device with first communication, a division unit which divides data shared in the first information processing device and the second information processing device, a first encryption unit which encrypts first data that is data that the first information processing device is to save among the data divided by the division unit with the first encryption key, a second communication unit which transmits second data that is data that the second information processing device is to save among the data divided by the division unit to the communication partner with second communication, and a first storage unit which stores the first data encrypted by the first encryption unit and the second encryption key, and the second information processing device includes a third communication unit which receives the first encryption key and the second encryption key transmitted from the first information processing device with the first communication, a fourth communication unit which receives the second data transmitted from the first information processing device with the second communication, a second encryption unit which encrypts the second data received by the fourth communication unit with the second encryption key received by the third communication unit, and a second storage unit which stores the second data encrypted by the second encryption unit and the first encryption key.

According to the embodiment, the first encryption key that the first information processing device uses and the second encryption key that the second information processing device uses are created, all the encryption keys are transmitted to the second information processing device with the first communication, the data shared with the first and second information processing devices is divided, the first data that is data that the first information processing device is to save out of the divided data is encrypted with the first encryption key, the second data that is data that the second information processing device is to save out of the divided data is transmitted to the communication partner with the second communication, and the encrypted first data and the second encryption key are stored. In addition, the first and second encryption keys transmitted from the first information processing device with the first communication are received, the second data transmitted from the first information processing device with the second communication is received, the received second data is encrypted with the received second encryption key, and the encrypted second data and the first encryption key are stored.

According to still another embodiment of the technology, there is provided an information processing device sharing data with another information processing device which includes a division unit which divides the data into a plurality of pieces, a creation unit which creates a plurality of encryption keys for encrypting the plurality of pieces of data divided by the division unit, a first communication unit which transmits at least two encryption keys out of the plurality of encryption keys created by the creation unit with first communication, an encryption unit which encrypts one piece of data out of the data divided by the division unit with a first encryption key out of the encryption keys transmitted by the first communication unit, a second communication unit which transmits other data that is data saved in the other information processing device among the data divided by the division unit to the other information processing device with second communication, and a storage unit which stores the data encrypted by the encryption unit and an encryption key other than the first encryption key out of the encryption keys transmitted to the other information processing device.

According to still another embodiment of the technology, there is provided an information processing method of an information processing device sharing data with another information processing device, which includes dividing the data into a plurality of pieces, creating a plurality of encryption keys for encrypting the plurality of pieces of data divided in the division process, first-communicating which transmits at least two encryption keys out of the plurality of encryption keys created in the creation process with the first communication to the other information processing device, encrypting one piece of data out of the data divided in the division process with a first encryption key out of the encryption keys transmitted in the first communication process, second-communicating which transmits other data that is data saved in the other information processing device among the data divided in the division process to the other information processing device with the second communication, and storing the data encrypted in the encryption process and an encryption key other than the first encryption key out of the encryption keys transmitted to the other information processing device.

According to the embodiment, data is divided into a plurality of pieces, a plurality of encryption keys for encrypting the plurality of pieces of divided data is created, at least two encryption keys out of a created plurality of encryption keys are transmitted to the other information processing device with the first communication, one piece of data out of the divided data is encrypted with the first encryption key out of the transmitted encryption keys, other data that is data that the other information processing device is to save out of the divided data is transmitted to the other information processing device with the second communication, and the encrypted data and an encryption key other than the first encryption key out of the encryption keys transmitted to the other information processing device are stored.

According to still another embodiment of the technology, there is provided an information processing device sharing data with another information processing device which includes a first communication unit which receives at least two encryption keys transmitted from the other information processing device with first communication, a second communication unit which receives own data that is data that the device is to save for itself out of the data divided in and transmitted from the other information processing device with second communication, an encryption unit which encrypts its own data received by the second communication unit with a first encryption key out of the encryption keys received by the first communication unit, and a storage unit which stores its own data encrypted by the encryption unit and an encryption key other than the first encryption key out of the encryption keys transmitted from the other information processing device.

According to the embodiment, at least two encryption keys transmitted from the other information processing device with the first communication are received, the own data that the device is to save for itself out of data divided in and transmitted from the other information processing device with the second communication is received, the received own data is encrypted with the first encryption key out of the received encryption keys, and the encrypted own data and a encryption key other than the first encryption key out of the encryption keys transmitted from the other information processing device are stored.

According to still another embodiment of the technology, there is provided an information processing system constituted by a first information processing device and a second information processing device, in which the first information processing device includes a division unit which divides the data into a plurality of pieces, a creation unit which creates a plurality of encryption keys for encrypting the plurality of pieces of data divided by the division unit, a first communication unit which transmits at least two encryption keys out of the plurality of encryption keys created by the creation unit to the second information processing device with first communication, a first encryption unit which encrypts first data out of the data divided by the division unit with a first encryption key out of the encryption keys transmitted by the first communication unit, a second communication unit which transmits second data that is data saved in the second information processing device out of the data divided by the division unit to the second information processing device with second communication, and a storage unit which stores the first data encrypted by the first encryption unit and an encryption key other than the first encryption key out of the encryption keys transmitted to the second information processing device, and the second information processing device includes a third communication unit which receives at least the two encryption keys transmitted from the first information processing device with the first communication, a fourth communication unit which receives the second data transmitted from the first information processing device with the second communication, a second encryption unit which encrypts the second data received by the fourth communication unit with a second encryption key out of the encryption keys received by the third communication unit, and a storage unit which stores the second data encrypted by the second encryption unit and an encryption key other than the second encryption key out of the encryption keys transmitted from the first information processing device.

According to the embodiment, the data is divided into a plurality of pieces, a plurality of encryption keys for encrypting the plurality of pieces of divided data is created, at least two encryption keys out of the generated plurality of encryption keys are transmitted to the second information processing device with the first communication, the first data out of the divided data is encrypted with the first encryption key out of the transmitted encryption keys, the second data that is data saved in the second information processing device out of the divided data is transmitted to the second information processing device with the second communication, and the encrypted first data and an encryption key other than the first encryption key out of the encryption keys transmitted to the second information processing device are stored. In addition, at least two encryption keys transmitted from the first information processing device with the first communication are received, the second data transmitted from the first information processing device with the second communication is received, the received second data is encrypted with the second encryption key out of the received encryption keys, and the encrypted second data and an encryption key other then the second encryption key out of the encryption keys transmitted from the first information processing device are stored.

According to the embodiments of the technology, it is possible to store data more conveniently and safely.

### BRIEF DESCRIPTION OF THE DRAWINGS

FIG. 1 is a diagram showing a configuration example of a communication system according to an embodiment of the present disclosure;

FIG. 2 is a block diagram showing a configuration example of a mobile telephone of FIG. 1;

FIG. 3 is a block diagram showing a functional configuration example of the mobile telephones;

FIG. 4 is a diagram illustrating the displays on the displays of the mobile telephones;

FIG. 5 is a diagram illustrating the displays on the display of one of the mobile telephones;

FIG. 6 is a flowchart illustrating a data saving process of the communication system of FIG. 1;

FIG. 7 is a diagram illustrating the exchange of data between the mobile telephones;

FIG. 8 is a diagram showing an example of a data information table;

FIG. 9 is a diagram showing an example of a user information table;

FIG. 10 is a diagram illustrating the displays on the displays of the mobile telephones;

FIG. 11 is a diagram illustrating the displays on the displays of the mobile telephones;

FIG. 12 is a diagram illustrating the displays on the displays of the mobile telephones;

FIG. 13 is a diagram illustrating the displays on the displays of the mobile telephones;

FIG. 14 is a flowchart illustrating a data restoration process of the communication system of FIG. 1;

FIG. 15 is a diagram illustrating the exchange of data between the mobile telephones;

FIG. 16 is a diagram illustrating the displays on the display of one of the mobile telephones;

FIG. 17 is a diagram showing a configuration example of another communication system according to another embodiment of the disclosure;

FIG. 18 is a diagram illustrating the displays on a display of a device A of FIG. 17;

FIG. 19 is a diagram illustrating the displays of the display of the device A;

FIG. 20 is a flowchart illustrating a data saving process of the communication system of FIG. 17;

FIG. 21 is a flowchart illustrating the data saving process of the communication system of FIG. 17;

FIG. 22 is a diagram illustrating key data;

FIG. 23 is a diagram illustrating user information;

FIG. 24 is a diagram illustrating application data information;

FIG. 25 is a diagram showing an example of a user information table;

FIG. 26 is a diagram showing an example of a data information table;

FIG. 27 is a diagram illustrating an example of a distribution process and an encryption process;

FIG. 28 is a diagram illustrating another example of a distribution process and an encryption process;

FIG. 29 is a diagram illustrating the displays on the displays of devices;

FIG. 30 is a flowchart illustrating a data restoration process of the communication system of FIG. 17;

FIG. 31 is a flowchart illustrating the data restoration process of the communication system of FIG. 17;

FIG. 32 is a diagram illustrating the displays on the displays of the devices;

FIG. 33 is a diagram illustrating key data;

FIG. 34 is a diagram illustrating the displays on the displays of the devices;

FIG. 35 is a diagram illustrating the displays on the displays of the devices; and

FIG. 36 is a diagram illustrating an example of a decryption process and a restoration process.

### DETAILED DESCRIPTION OF EMBODIMENTS

Hereinafter, embodiments of the present disclosure will be described with reference to drawings. The description will be provided in the order as below, but the system of communication among three devices in a second embodiment may be applied to the communication between two devices in the first embodiment.

1. First Embodiment (An example in which communication is performed between two devices)

2. Second Embodiment (An example in which communication is performed between three devices)

### 1. First Embodiment

### [Configuration Example of Communication System]

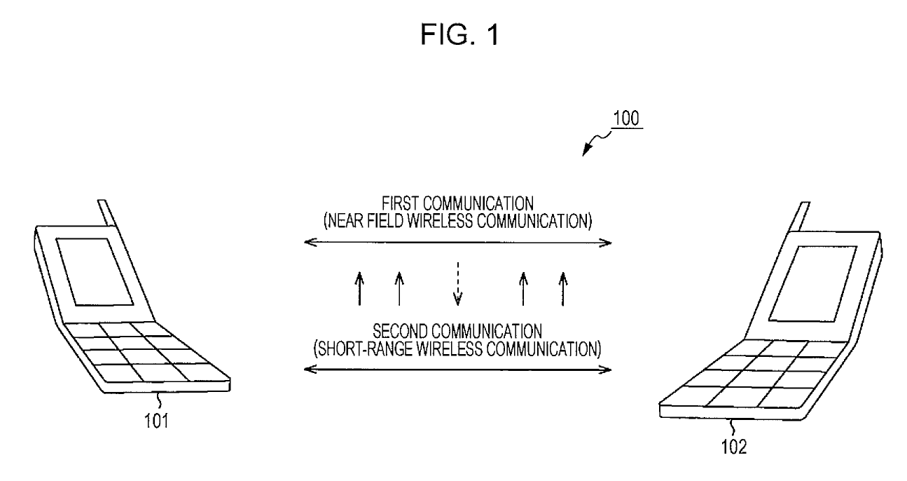

FIG. 1 is a diagram showing a configuration example of a communication system according to an embodiment of the present disclosure. In FIG. 1, the communication system 100 is a system in which wireless communication is performed between a plurality of devices, data is exchanged, and applications are executed based on the data. As shown in FIG. 1, the communication system 100 includes, for example, a mobile telephone 101 and a mobile telephone 102.

The mobile telephone 101 and the mobile telephone 102 perform communication with each other by means of two communication types, which are a first communication and a second communication. The first communication is performed to exchange information necessary for the exchange of data. For example, Near Field Wireless Communication is used as the first communication. The second communication is performed to exchange data for operating an application to be executed in each of the mobile telephone 101 and the mobile telephone 102. For example, Short-Range Wireless Communication is used as the second communication.

Furthermore, herein, Near Field Wireless Communication refers to a wireless communication system that enables communication in a state of the casings of the mobile telephone 101 and the mobile telephone 102 coming into contact with each other or coming close to a communication partner up to a distance to an extent that the partner can be visually specified, for example, about several centimeters. For example, there is a wireless communication system using electromagnetic induction such as non-contact IC (Integrated Circuit) cards. Furthermore, hereinbelow, description will be provided without discriminating “contact” and “close” described above unless specified otherwise. In other words, hereinbelow, any action described with “close” also includes “contact”, and vice versa.

In addition, Short-Range Wireless Communication refers to a wireless communication system that enables communication in a state of positioning the casings of the mobile telephone 101 and the mobile telephone 102 to a short-range (for example, about dozens meters or shorter). For example, there are Bluetooth (registered trademark) standard and WiFi (Wireless Fidelity) standard (WiFi-certified IEEE (Institute of Electrical and Electronic Engineers) 802.11x).

Generally, in the case of Near Field Wireless Communication used as the first communication, it is easy to specify a communication partner from a physical restriction on the communication range, and accordingly, it is easier to perform a setting operation for establishing communication connection than Short-Range Wireless Communication. For example, when a plurality of devices is present within the communication range in Short-Range Wireless Communication, it is necessary for a user to designate a device with which communication is to be performed. On the contrary, since Near Field Wireless Communication has a narrow communication range, the communication partner is basically limited to one. Thus, in that case, it is necessary for a user to contact his or her own operating device to a device of the communication partner, however the action itself is designation of a communication partner, therefore, it is not necessary to input designation of a communication partner once more.

However, Near Field Wireless Communication generally has a lower data transmission rate than Short-Range Wireless Communication, and thus is not suitable for large-capacity data transmission. In addition, devices have to contact to each other in the middle of communication, but it is considered that maintaining the disposition (positional relationship between the devices) is difficult. Furthermore, it is difficult to perform communication between three or more devices.

In light of the points above, in the communication system 100, the exchange of data for operating applications (applications executed in the mobile telephones 101 and 102) is performed with the second communication (Short-Range Wireless Communication), and the first communication (Near Field Wireless Communication) is used in the exchange of information necessary for the exchange of data. In other words, the mobile telephones 101 and 102 perform the first communication first, and prepare connection of the second communication by exchanging information necessary for the exchange of data. If the connection of the second communication is established, the mobile telephones 101 and 102 perform the exchange of data to operate applications by using the second communication.

Furthermore, a communication device composing the communication system 100 may be any communication device if the device can perform both the first communication and the second communication. For example, such a communication device may be one that can perform both the first communication that performs communication in a distance that a communication partner can be visually specified in the positional relationship between devices during communication and the second communication of which the communication range is wider than that of the first communication and which performs communication in a distance that visual specification of a communication partner is difficult in the positional relationship between devices during communication.

After all, a communication device composing the communication system 100 may be any device other than the mobile telephones 101 and 102 described above. For example, such a device may be a television receiver, a video recorder, a media player, an audio amplifier, an audio component, a printer, a fax machine, a car audio system, a car navigation system, or the like. Of course, any device other than these is possible. In addition, such devices may be ones composing the communication system 100 which have different functions from each other, for example, a mobile telephone and an audio component.

Furthermore, the number of communication devices composing the communication system 100 is arbitrary, and may be three or more. Furthermore, the first communication may not be Near Field Wireless Communication. In addition, the second communication may not necessarily be Short-Range Wireless Communication. Moreover, the first and the second communication may be performed via a repeater or a network. In addition, the first and the second communication may be wired communication performed via wires. However, since the first communication is for exchanging information necessary for the exchange of data to be performed in the second communication as described above, it is desirable to make a setting operation for communication start either an easy or unnecessary operation, such as making specification of a communication partner easy.

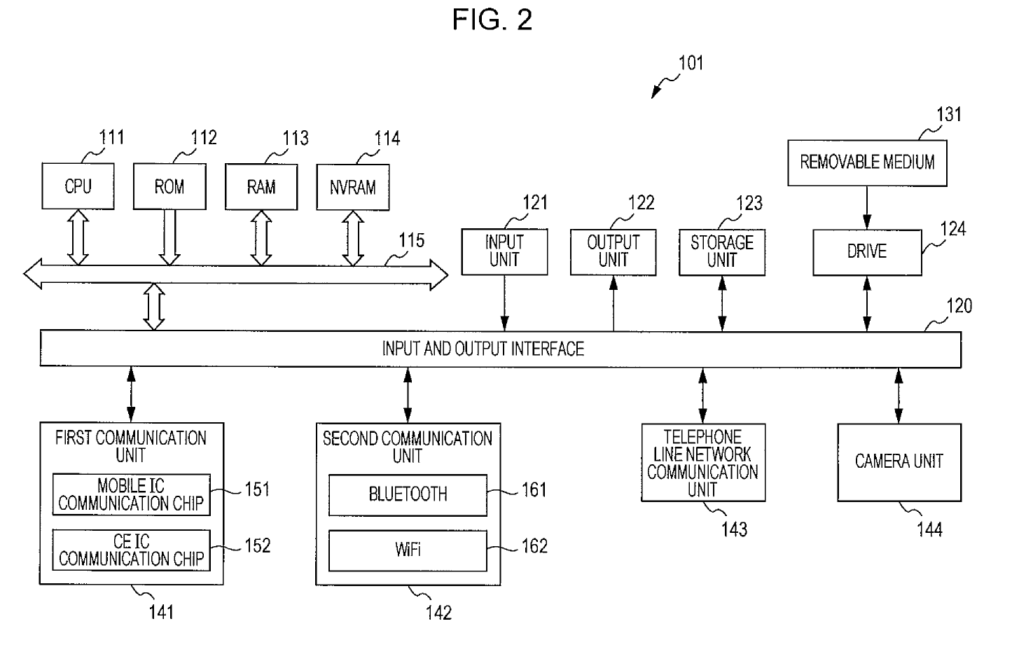

FIG. 2 is a block diagram showing a configuration example of the inside of the mobile telephone 101 shown in FIG. 1.

In FIG. 2, a CPU (Central Processing Unit) 111 of the mobile telephone 101 is an arithmetic processing unit that performs various processes by performing software programs. The CPU 111 is connected to a ROM (Read Only Memory) 112, a RAM (Random Access Memory) 113, and an NVRAM (Non-Volatile RAM) 114 to one another via a bus 115. The ROM 112 stores software programs and data in advance. The RAM 113 and the NVRAM 114 load the software programs and data stored in the RAM 112 or a storage unit 123 therein. The RAM 113 and the NVRAM 114 also appropriately store data and the like necessary for the CPU 111 to perform various processes.

The bus 115 is also connected to an input and output interface 120. The input and output interface 120 is connected to an input unit 121 including a keyboard, a mouse, and the like. In addition, the input and output interface 120 is connected to an output unit 122 including a display including a CRT (Cathode Ray Tube) display, an LCD (Liquid Crystal Display), or the like, a speaker, and the like. Furthermore, the input and output interface 120 is connected to the storage unit 123 including a flash memory, a hard disk, and the like.

Moreover, the input and output interface 120 is connected to a drive 124 according to necessity, a removable medium 131 such as a magnetic disk, an optical disc, a magneto-optical disc, a semiconductor memory, or the like is appropriately loaded into the drive, and a computer program read from such a medium is installed in the storage unit 123 according to necessity.

Furthermore, the input and output interface 120 is connected to a first communication unit 141 which performs the first communication and a second communication unit 142 which performs the second communication. In addition, the input and output interface 120 is connected to a telephone line network communication unit 143 which includes a modem or the like and performs voice communication or packet communication with other devices via a public telephone line network. Moreover, the input and output interface 120 is connected to a camera unit 144 which has digital camera functions of photographing a subject and obtaining image data thereof.

The first communication unit 141 is a wireless communication unit which performs Near Field Wireless Communication as described above. The first communication unit 141 has a mobile-device IC communication chip 151 which is a wireless communication section that performs communication in a communication system used in non-contact IC cards (hereinbelow, referred to as a mobile IC communication chip 151). In addition, the first communication unit 141 has a digital-consumer-electronics IC communication chip 152 (hereinafter, referred to as a CE (Consumer Electronics) IC communication chip 152). The mobile IC communication chip 151 and the CE IC communication chip 152 performs communication based on different communication standards from each other. The first communication unit 141 selectively uses one of them.

The second communication unit 142 is a wireless communication unit which performs Short-Range wireless communication as described above. The second communication unit 142 has a Bluetooth (registered trademark) 161 that is a wireless communication part for performing wireless communication with Bluetooth standard. In addition, the second communication unit 142 has a WiFi 162 that is a WiFi-certified wireless communication part which performs wireless communication with IEEE802.11x standard. The second communication unit 142 selectively uses one of them.

Furthermore, in FIG. 2, it is described that two kinds of communication parts are provided in each of the first communication unit 141 and the second communication unit 142, but it does not matter how many communication parts (kinds) are provided in each unit. In addition, the first communication unit 141 may perform the first communication, and the second communication unit 142 may perform the second communication. In other words, the communication standard of the communication parts included in the first communication unit 141 and the second communication unit 142 is arbitrary, and any standard other than those described above is possible.

Furthermore, the mobile telephone 101 may be designed to have a configuration other than the one described above. In addition, some functions such as the camera unit 144 may be omitted.

Since the mobile telephone 102 that is the communication partner of the mobile telephone 101 basically has the same configuration as that of the mobile telephone 101 described with reference to FIG. 2, description on the configuration of the mobile telephone 102 will be omitted. In other words, the description on FIG. 2 can be applied also to the mobile telephone 102, and when the configuration of the mobile telephone 102 is to be described, FIG. 2 is used for the description in the same manner as the mobile telephone 101. Hereinbelow, description is provided such that the side requesting a handover process is assumed to be the mobile telephone 101 and the side responding thereto is assumed to be the mobile telephone 102, but a case where one device serves as both the requesting side and the responding side is considered depending on circumstances, and thus, it is not necessary to make configurations of the requesting side and the responding side differ from each other. Therefore, hereinbelow, the configurations of the mobile telephones 101 and 102 will be described to be basically the same as each other. In other words, the description on the configuration of the mobile telephone 101 can be applied to the description on that of the mobile telephone 102.

### [Functional Configuration Example of Mobile Telephone]

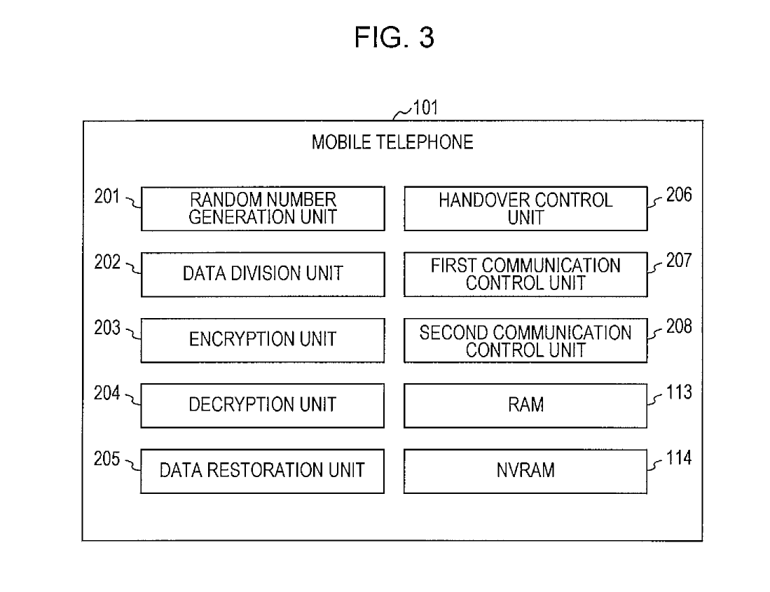

Next, a functional configuration example of the mobile telephone 101 will be described with reference to FIG. 3.

The mobile telephone 101 of FIG. 3 is composed of the RAM 113, the NVRAM 114, a random number generator 201, a data division unit 202, an encryption unit 203, a decryption unit 204, a data restoration unit 205, a handover control unit 206, a first communication control unit 207, and a second communication control unit 208.

Furthermore, since the RAM 113 and the NVRAM 114 in FIG. 3 are the same as the RAM 113 and the NVRAM 114 of the mobile telephone 101 in FIG. 2, description thereof will be omitted.

The random number generator 201 generates random numbers that become encryption keys used in data encryption performed by the encryption unit 203.

The data division unit 202 divides data that is exchanged using the second communication and used for operating applications (hereinafter, appropriately referred to as application data) using a predetermined algorithm (distribution method).

The encryption unit 203 encrypts data divided by the data division unit 202 using a predetermined algorithm (encrypting method).

The decryption unit 204 decrypts the encrypted data with the same algorithm as the one used in the encryption.

The data restoration unit 205 restores the divided data with the same algorithm as the one used in the division.

The handover control unit 206 controls the first communication control unit 207 and the second communication control unit 208 to perform a process in which the first communication with the communication partner is established, and then the second communication with the communication partner is established (a handover process).

The first communication control unit 207 controls the first communication unit 141 to perform a process relating to the first communication.

The second communication control unit 208 controls the second communication unit 142 to perform a process relating to the second communication.

### [Data Saving in Communication System]

Next, data saving in the communication system 100 will be described.

In the communication system 100, the mobile telephones 101 and 102 can share and save application data by performing communication with each other.

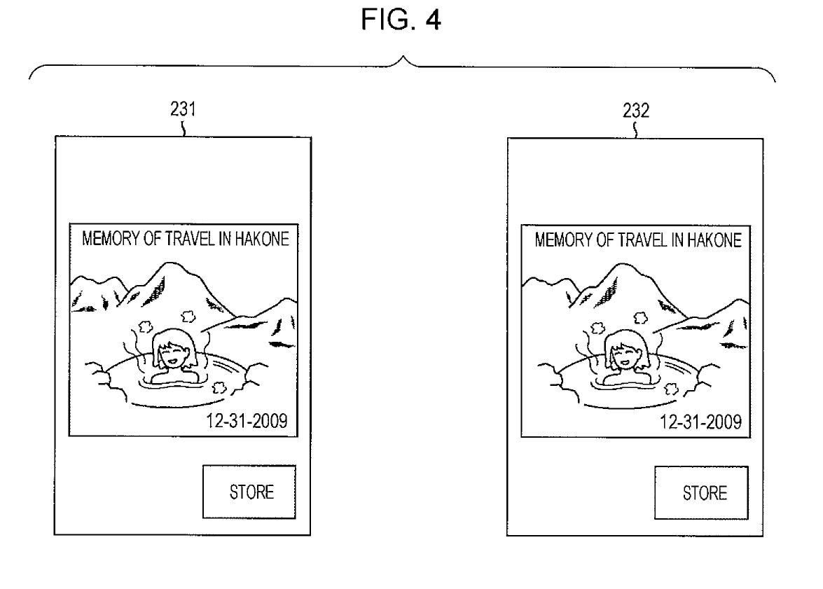

For example, if the RAM 113s of the mobile telephones 101 and 102 hold the same application data, a display 231 of the mobile telephone 101 and a display 232 of the mobile telephone 102 displays images displayed by application data (image data) held in each of the mobile telephones 101 and 102 and a “save” button as a GUI (Graphical User Interface) which users use for instructing the saving of the image data, for example, as shown in FIG. 4.

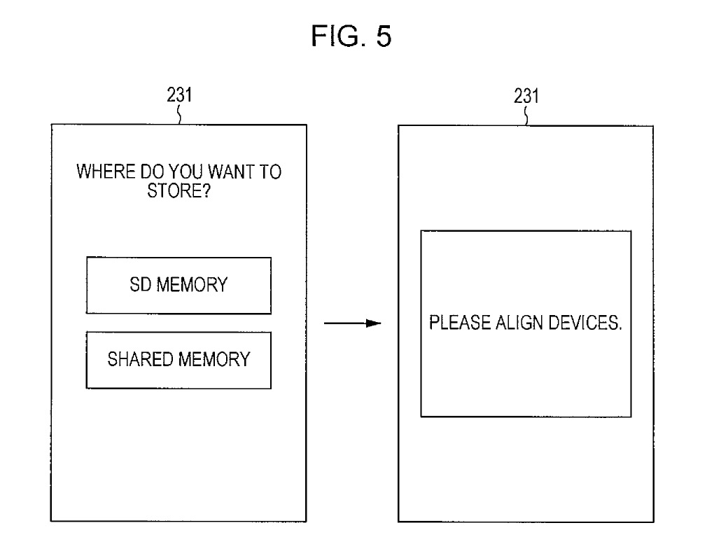

If either user of the mobile telephone 101 or the mobile telephone 102 (in this case, the user of the mobile telephone 101) selects the “save” button from the state of FIG. 4, the display 231 of the mobile telephone 101 displays the message “Where do you want to save?” for asking about the saving place of the image data and an “SD memory” button and a “shared memory” button for selecting a candidate of the saving places as shown in the left side of FIG. 5.

Herein, when the user of the mobile telephone 101 selects the “SD memory” button, the image data held in the RAM 113 of the mobile telephone 101 is saved in the NVRAM 114 of the mobile telephone 101. On the other hand, when the user of the mobile telephone 101 selects the “shared memory” button, the display 231 of the mobile telephone 101 displays a message “please align devices” as shown in the right side of FIG. 5, and prompts the user of the mobile telephone 101 to bring the casing of the mobile telephone 101 close to or into contact with the casing of the mobile telephone 102.

Then, if the casing of the mobile telephone 101 comes close to or into contact with the casing of the mobile telephone 102, a data saving process for sharing and saving data by the mobile telephones 101 and 102 is performed in the communication system 100.

### [Data Saving Process]

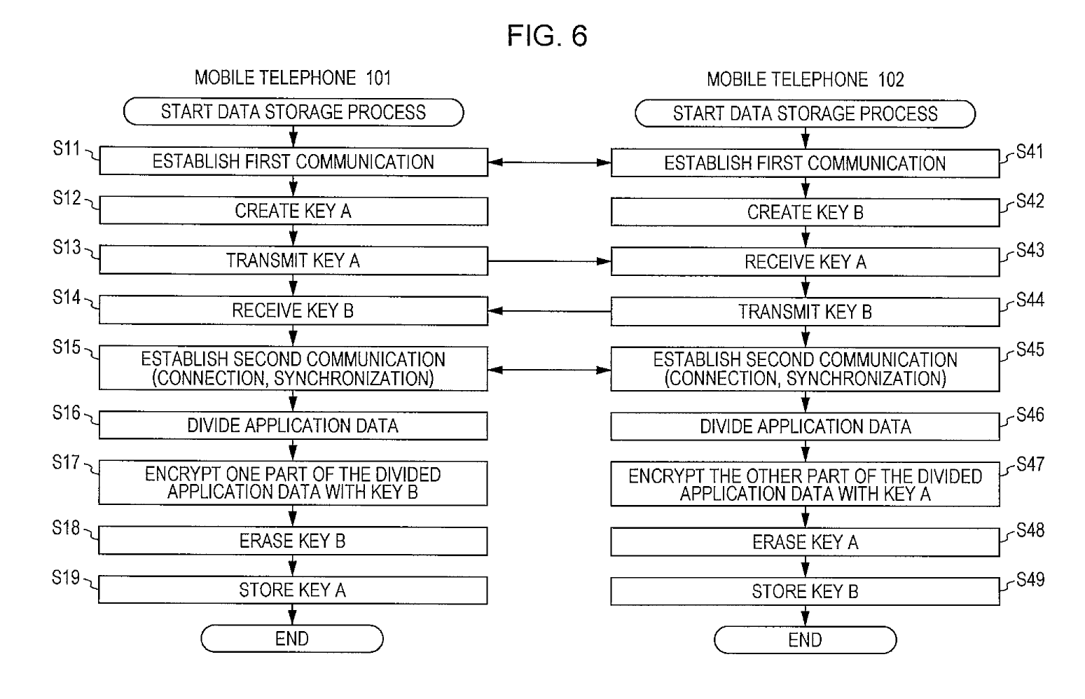

The data saving process of the mobile telephones 101 and 102 in the communication system 100 will be described with reference to the flowchart of FIG. 6.

In Step S11, the handover control unit 206 of the mobile telephone 101 controls the first communication control unit 207 to establish the first communication between the mobile telephone 102. On the other hand, in Step S41, the handover control unit 206 of the mobile telephone 102 controls the first communication control unit 207 to establish the first communication between the mobile telephone 101.

If the first communication is established, the random number generator 201 of the mobile telephone 101 creates a key A that is an encryption key by generating random numbers in Step S12. In addition, the random number generator 201 of the mobile telephone 102 creates a key B that is an encryption key by generating random numbers in Step S42.

If the key A is created, the first communication control unit 207 of the mobile telephone 101 controls the first communication unit 141 to transmit the key A created in the random number generator 201 to the mobile telephone 102 in Step S13. On the other hand, the first communication control unit 207 of the mobile telephone 102 controls the first communication unit 141 to receive the key A transmitted from the mobile telephone 101 in Step S43.

In addition, in Step S44, the first communication control unit 207 of the mobile telephone 102 controls the first communication unit 141 to transmit the key B created in the random number generator 201 to the mobile telephone 101. On the other hand, in Step S14, the first communication control unit 207 of the mobile telephone 101 controls the first communication unit 141 to receive the key B transmitted from the mobile telephone 102.

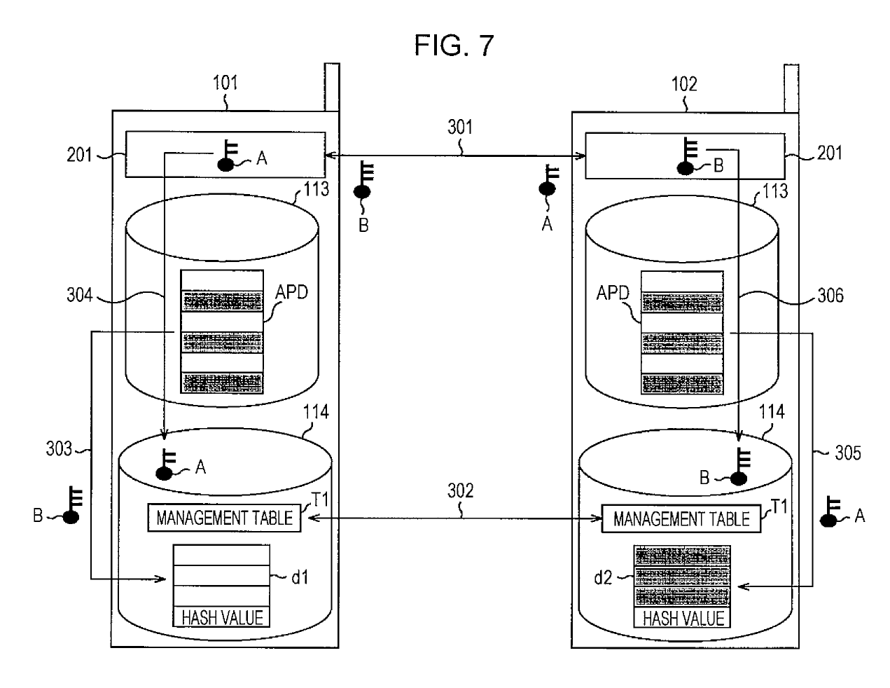

In other words, as shown by an arrow 301 of FIG. 7, the key A created in the random number generator 201 of the mobile telephone 101 is supplied to the mobile telephone 102 and the key B created in the random number generator 201 of the mobile telephone 102 is supplied to the mobile telephone 101.

FIG. 7 is a diagram illustrating the exchange of data between the mobile telephones 101 and 102.

As shown in FIG. 7, the RAMs 113 of the mobile telephones 101 and 102 hold the same application data APD respectively. In addition, the NVRAM 114 of the mobile telephone 101 stores (saves) a management table T1 and encrypted data d1 to be described later, and the NVRAM 114 of the mobile telephone 102 stores a management table T1 and encrypted data d2 to be described later.

Returning to the flowchart of FIG. 6, the handover control unit 206 of the mobile telephone 101 controls the second communication control unit 208 to establish the second communication between the mobile telephone 102 in Step S15. On the other hand, the handover control unit 206 of the mobile telephone 102 controls the second communication control unit 208 to establish the second communication between the mobile telephone 101 in Step S45.

At this time, the mobile telephones 101 and 102 are connected to each other with the second communication as shown by an arrow 302 of FIG. 7, and in synchronization with the management tables T1 including information regarding the communication partner of each other.

The management table T1 is divided into a group of devices (mobile telephones) sharing and saving application data, a data information table composed of information regarding application data shared and saved in the group, and a user information table which includes information regarding devices composing the group in which the application data is shared and saved.

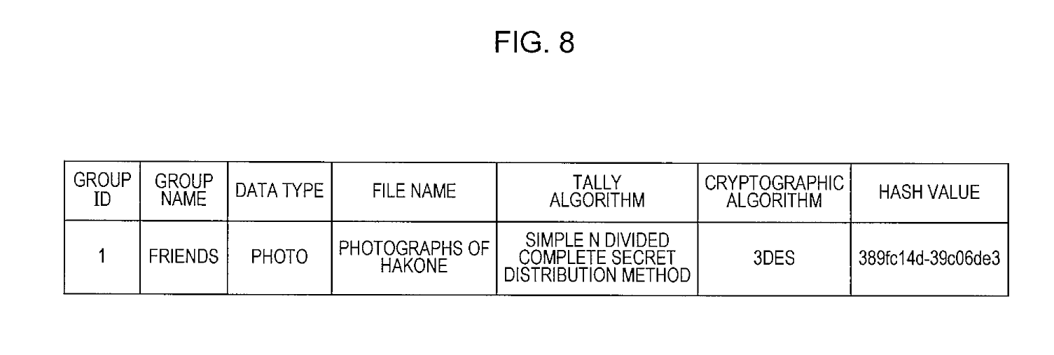

FIG. 8 shows an example of the data information table.

The data information table includes a Group ID that is information in which a group sharing application data is specified, a Group Name that is the name of the group, a data type that indicates the type of shared application data, a file name that indicates the file name of the application data as a file, a tally algorithm that indicates an algorithm used when the application data is divided so as to be shared, a cryptographic algorithm that indicates an algorithm used when the divided application data is encrypted, and a hash value used for checking the validity of the divided application data when the data is restored.

In FIG. 8, the Group ID is set to “1”, the Group Name to “friends”, the data type to “Photo” indicating that the data includes photographs, and the file name to “photographs of Hakone”. In addition, the tally algorithm is set to a “simple n divided complete secret distribution method”, the cryptographic algorithm to “3DES (Data Encryption Standard) (which is also referred to as a “triple DES)”, and the hash value to “389fc14d-39c06de3”.

Furthermore, the tally algorithm and the cryptographic algorithm may be set in any device within the group in advance, and may be set by a user. In addition, the hash value is obtained based on the application data retained in the RAM 113 when, for example, the second communication is established.

The mobile telephones 101 and 102 can share information on the application data divided and saved in the group with the data information table.

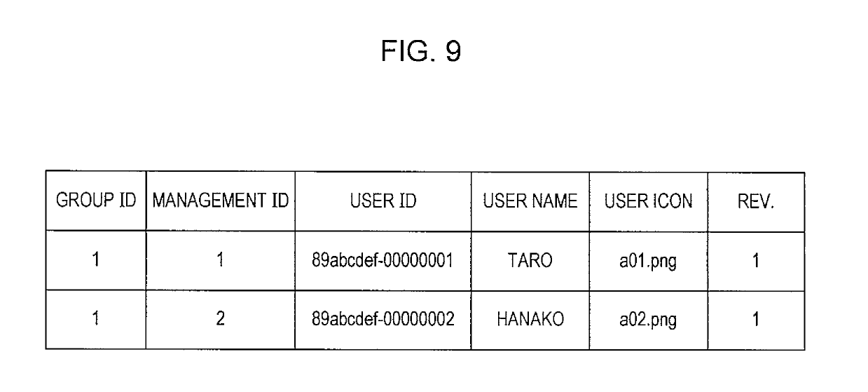

FIG. 9 shows an example of a user information table.

The user information table includes a Group ID for specifying a group to which devices including a user's own one belong, a management ID that is information for managing each device for communication within the group, a User ID for specifying users who use each device within the group, a User Name indicating the names of the users, a User Icon indicating a file name for displaying an icon expressing the users, and a Rev. (Revision) indicating the version of the application data saved in each device within the group.

FIG. 9 shows information on two devices (the mobile telephones 101 and 102) to which a group whose the Group ID is “1” belongs. Specifically, for the mobile telephone 101, the management ID is set to “1”, the User ID to “89abcdef-00000001”, the User Name to “Taro”, the User Icon to “a01.png”, and the Rev. to “1”. In addition, for the mobile telephone 102, the management ID is set to “2”, the User ID to “89abcdef-00000002”, the User Name to “Hanako”, the User Icon to “a02.png”, and the Rev. to “1”.

In this case, the mobile telephone 101 of which the management ID is “1” is set to a master in the communication system 100, and the mobile telephone 102 of which the management ID is “2” is set to a slave in the communication system 100.

With the user information table, the mobile telephones 101 and 102 can share information on communication partners of the group of their own.

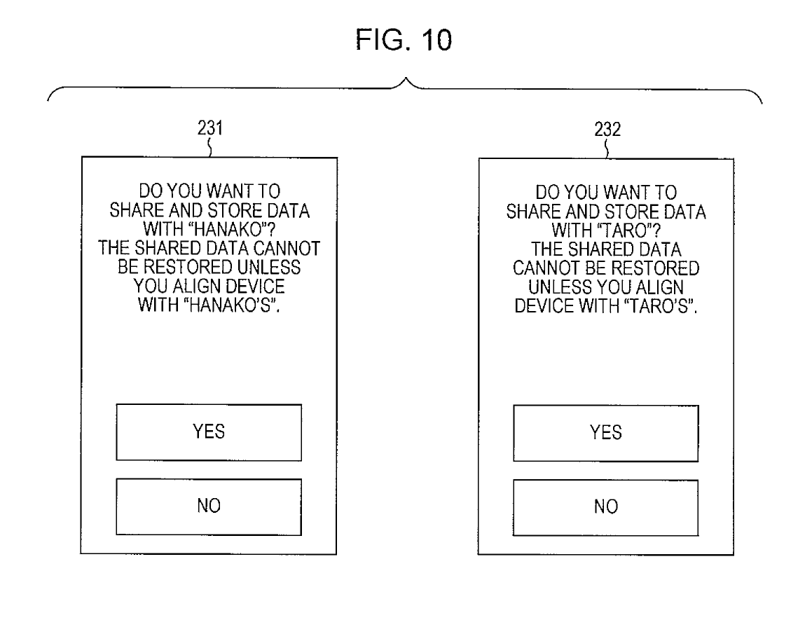

In addition, when the second communication is established in Steps S15 and S45 of the flowchart of FIG. 6, the display 231 of the mobile telephone 101 and the display 232 of the mobile telephone 102 display messages for prompting the users to select if the users want to share their devices and application data and save the data therein, and “Yes” and “No” buttons that enable the users to select sharing and saving of the application data as shown in FIG. 10.

Herein, if both or either “Taro” who is the user of the mobile telephone 101 and/or “Hanako” who is the user of the mobile telephone 102 select(s) “No” button, the process of the flowchart of FIG. 6 ends.

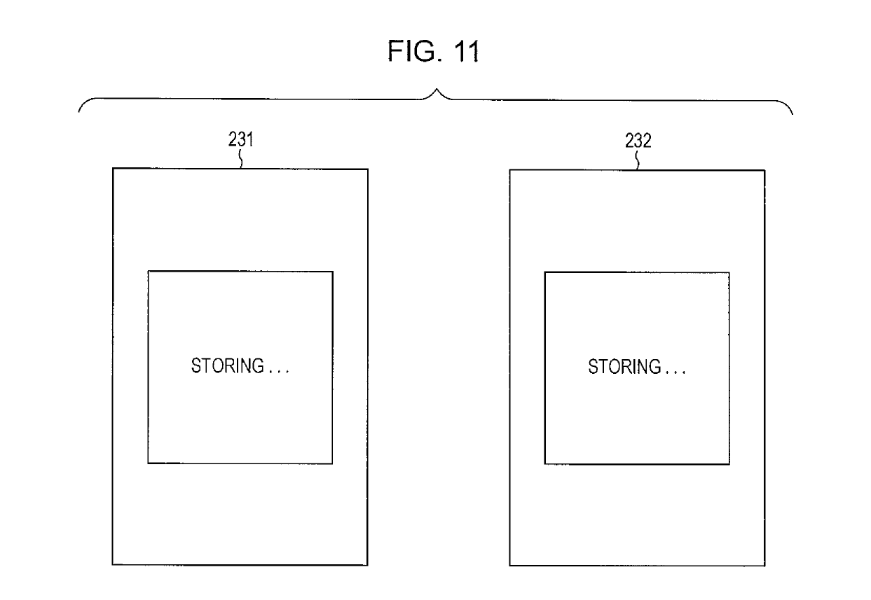

On the other hand, when both “Taro” and “Hanako” select “Yes” button, a message saying “saving . . . ” is displayed on the display 231 of the mobile telephone 101 and the display 232 of the mobile telephone 102 as shown in FIG. 11, and process after Steps S15 and S45 of the flowchart of FIG. 6 continues.

Now, returning to the flowchart of FIG. 6, the process advances to Step S16 after Step S15, and the data division unit 202 of the mobile telephone 101 divides the application data retained in the RAM 113 in a method set in the tally algorithm of the data information table of the management table T1. In the same manner, the process advances to Step S46 after Step S45, and the data division unit 202 of the mobile telephone 102 divides the application data retained in the RAM 113 in a method set in the tally algorithm of the data information table of the management table T1. For example, the application data APD retained in the RAM 113 of each of the mobile telephones 101 and 102 of FIG. 7 is divided into portions (data) indicated by white squares and portions (data) indicated by half-tone dot meshing squares.

In Step S17, the encryption unit 203 of the mobile telephone 101 encrypts one part of the divided application data with the key B transmitted (supplied) from the mobile telephone 102 in a method set in the cryptographic algorithm of the data information table of the management table T1. Specifically, as shown by an arrow 303 of FIG. 7, among the divided application data APD in the mobile telephone 101, the data indicated by the white squares is encrypted with the key B. At this time, the data indicated by the white squares is given with a hash value set in the data information table of the management table T1, and the data is encrypted. The encrypted data (encrypted data d1) is supplied to the NVRAM 114 and saved (stored).

In Step S18, the encryption unit 203 of the mobile telephone 101 erases the key B used in the encryption in Step S17. At this time, the encryption unit 203 also erases data that is not encrypted in Step S17 (the portion indicated by the half-tone dot meshing squares of FIG. 7) out of the divided application data, with the key B.

Then, in Step S19, the random number generation unit 201 of the mobile telephone 101 supplies the key A created in Step S12 as shown by an arrow 304 of FIG. 7 to the NVRAM 114 and makes the key saved (stored).

On the other hand, in Step S47, the encryption unit 203 of the mobile telephone 102 encrypts the other part of the divided application data with the key A transmitted (supplied) from the mobile telephone 101 in the method set in the cryptographic algorithm of the data information table of the management table T1. Specifically, as shown by an arrow 305 of FIG. 7, among the divided application data APD in the mobile telephone 102, the data indicated by the half-tone dot meshing squares is encrypted with the key A. At this time, the data indicated by the half-tone dot meshing squares is given with a hash value set in the data information table of the management table T1, and the data is encrypted. The encrypted data (encrypted data d2) is supplied to the NVRAM 114 and saved (stored).

In Step S48, the encryption unit 203 of the mobile telephone 102 erases the key A used in the encryption in Step S47. At this time, the encryption unit 203 also erases data that is not encrypted in Step S47 (the portion indicated by the white squares of FIG. 7) out of the divided application data, with the key A.

Then, in Step S49, the random number generation unit 201 of the mobile telephone 102 supplies the key B created in Step S42 to the NVRAM 114 as shown by an arrow 306 of FIG. 7 to the NVRAM 114 and makes the key saved (stored).

According to the above process, in the communication system 100, the application data retained in each of the mobile telephones 101 and 102 is divided in the same manner, and after the divided data is distributed to the mobile telephone 101 and 102, the data is encrypted with encryption keys created in each of the communication partners and saved. Accordingly, when the application data shared in the communication system 100 is to be restored, it is not possible to decrypt the encrypted data and to restore the original application data from the decrypted data only with either one of the mobile telephone 101 or the mobile telephone 102. In addition, in the communication system 100, the mobile telephones 101 and 102 are to exchange data through handover from the first communication to the second communication. Therefore, it is possible to save data more conveniently and safely.

Hereinabove, the process of sharing and saving the application data in the communication system 100 has been described, but hereinbelow, a process of restoring the stored application data will be described.

### [Restoration of Data in Communication System]

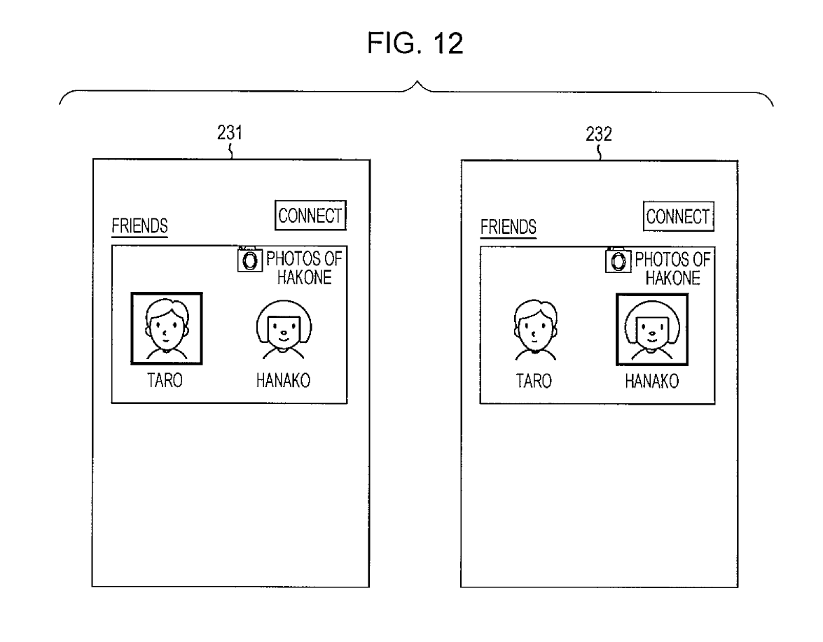

With the data saving process described above, when the application data is divided (distributed) and saved in the NVRAM 114 of the mobile telephones 101 and 102, if a user performs a predetermined operation, the display 231 of the mobile telephone 101 and the display 232 of the mobile telephone 102 display, for example, “friends” that is the name of the group to which the user belongs, an icon indicating users (“Taro” and “Hanako”) using devices belonging to the group, “Photos of Hakone” that is the file name of the shared application data as a file, and a “connect” button as a GUI for instructing connection (start of communication) used for the user to restore the application data as shown in FIG. 12 based on the user information table and the data information table of the management table T1 stored in each of the mobile telephones 101 and 102.

Furthermore, in FIG. 12, a frame that emphasizes the icon expressing the user himself/herself is displayed around the icon. In other words, the display 231 of the mobile telephone 101 displays a frame around the icon expressing “Taro” who is the user of the mobile telephone 101, and the display 232 of the mobile telephone 102 displays a frame around the icon expressing “Hanako” who is the user of the mobile telephone 102.

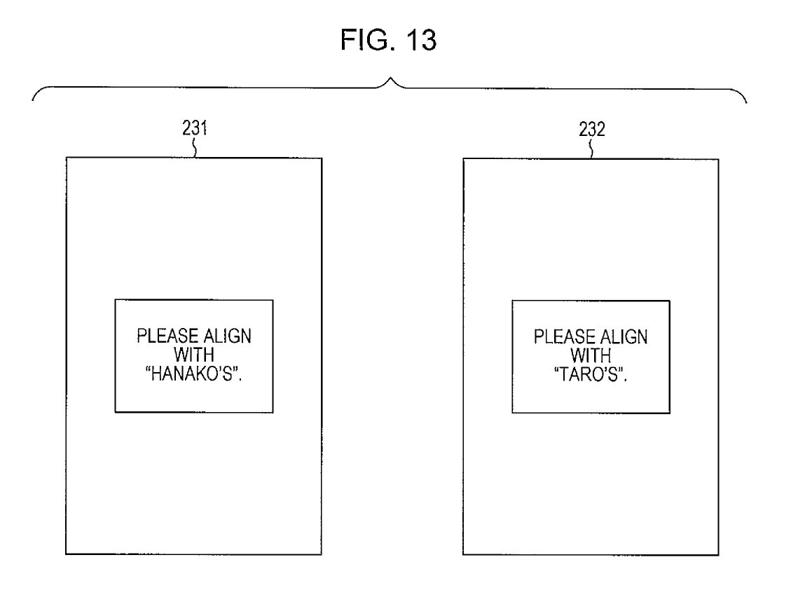

If the “connect” button is selected in the mobile telephones 101 and 102 from the state of FIG. 12, the display 231 of the mobile telephone 101 and the display 232 of the mobile telephone 102 display a message prompting each of the users to bring their casings close to or into contact with the casings of the communication partners as shown in FIG. 13. In other words, the display 231 of the mobile telephone 101 displays a message saying “please align with “Hanako's”” prompting the user to bring the casing of the mobile telephone 101 close to or into contact with the casing of the mobile telephone 102, and the display 232 of the mobile telephone 102 displays a message saying “please align with “Taro's” prompting the user to bring the casing of the mobile telephone 102 close to or into contact with the casing of the mobile telephone 101.

Then, if the casing of the mobile telephone 101 and the casing of the mobile telephone 102 come close to or into contact with each other from the state shown in FIG. 13, a data restoration process in which the mobile telephones 101 and 102 restore the distributed and saved data is executed in the communication system 100.

### [Data Restoration Process]

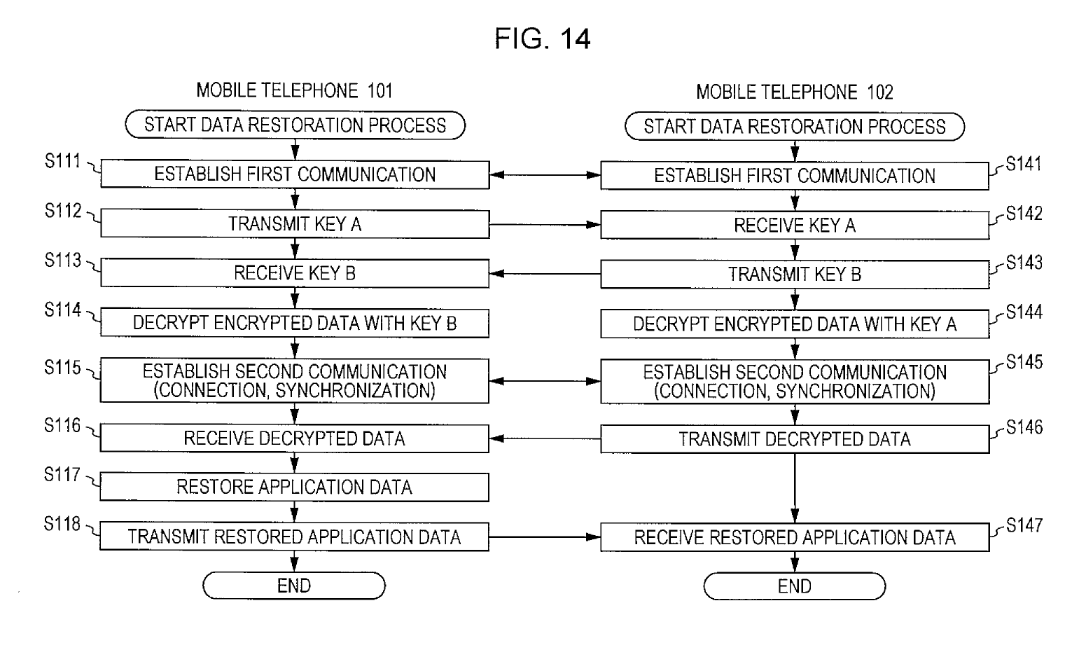

Hence, the data restoration process of the mobile telephones 101 and 102 in the communication system 100 will be described with reference to the flowchart of FIG. 14.

In Step S111, the handover control unit 206 of the mobile telephone 101 controls the first communication control unit 207 and establishes the first communication with the mobile telephone 102. On the other hand, in Step S141, the handover control unit 206 of the mobile telephone 102 controls the first communication control unit 207 and establishes the first communication with the mobile telephone 101.

When the first communication is established, the first communication control unit 207 of the first mobile telephone 101 controls the first communication unit 141 to transmit the key A stored in the NVRAM 114 to the mobile telephone 102 in Step S112. On the other hand, the first communication control unit 207 of the first mobile telephone 102 controls the first communication unit 141 to receive the key A transmitted from the mobile telephone 101 in Step S142.

In addition, the first communication control unit 207 of the mobile telephone 102 controls the first communication unit 141 to transmit the key B stored in the NVRAM 114 to the mobile telephone 101 in Step S143. On the other hand, the first communication control unit 207 of the mobile telephone 101 controls the first communication unit 141 to receive the key B transmitted from the mobile telephone 102 in Step S113.

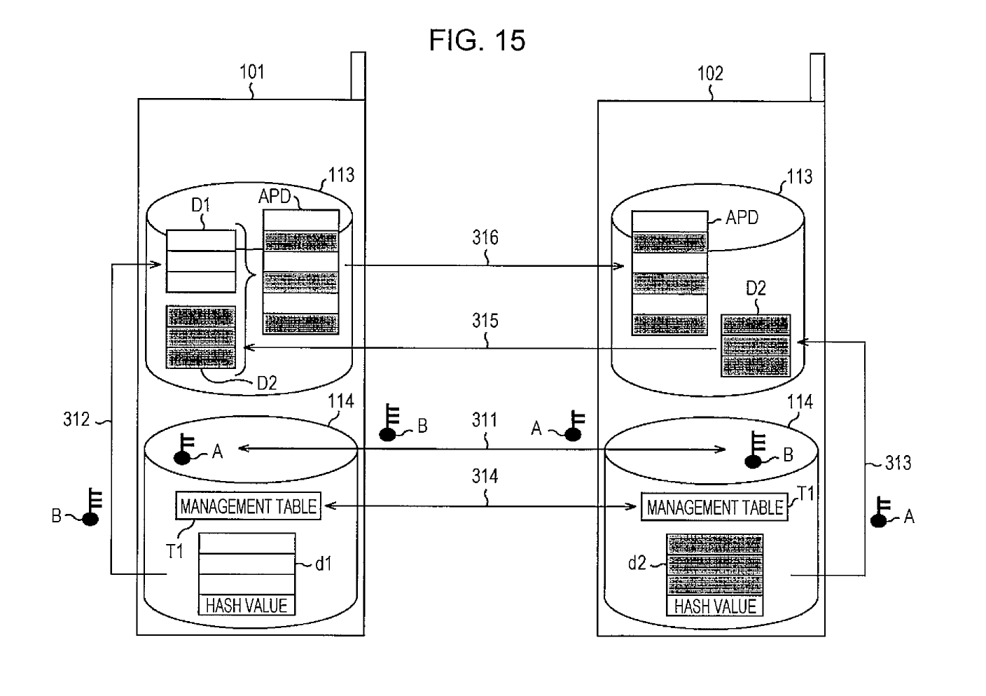

In other words, as shown by an arrow 311 of FIG. 15, the key A saved in the NVRAM 114 of the mobile telephone 101 is supplied to the mobile telephone 102, and the key B saved in the NVRAM 114 of the mobile telephone 102 is supplied to the mobile telephone 101.

FIG. 15 is a diagram illustrating the exchange of data between the mobile telephones 101 and 102.

As shown in FIG. 15, the NVRAM 114 of the mobile telephone 101 stores the management table T1 and the encrypted data d1, and the NVRAM 114 of the mobile telephone 102 stores the management table T1 and the encrypted data d2. In addition, the RAM 113 of the mobile telephone 101 retains decrypted data D1 to be described later, and the RAM 113 of the mobile telephone 102 retains decrypted data D2 to be described later.

Returning to FIG. 14, the decryption unit 204 of the mobile telephone 101 decrypts the encrypted data stored in the NVRAM 114 with the key B transmitted (supplied) from the mobile telephone 102 in a method set in the cryptographic algorithm of the data information table of the management table T1 in Step S114. Specifically, as shown by an arrow 312 of FIG. 15, the encrypted data d1 stored in the NVRAM 114 of the mobile telephone 101 is decrypted with the key B. The decrypted data (decrypted data D1) is supplied to the RAM 113 and retained therein. At this time, the hash value assigned to the encrypted data d1 is also retained in the RAM 113 together with the decrypted data D1.

On the other hand, the decryption unit 204 of the mobile telephone 102 decrypts the encrypted data stored in the NVRAM 114 with the key A transmitted (supplied) from the mobile telephone 101 in a method set in the cryptographic algorithm of the data information table of the management table T1 in Step S144. Specifically, as shown by an arrow 313 of FIG. 15, the encrypted data d2 stored in the NVRAM 114 of the mobile telephone 102 is decrypted with the key A. The decrypted data (decrypted data D2) is supplied to the RAM 113 and retained therein. At this time, the hash value assigned to the encrypted data d2 is also retained in the RAM 113 together with the decrypted data D2.

The handover control unit 206 of the mobile telephone 101 controls the second communication control unit 208 to establish the second communication with the mobile telephone 102 in Step S115. On the other hand, the handover control unit 206 of the mobile telephone 102 controls the second communication control unit 208 to establish the second communication with the mobile telephone 101 in Step S145.

At this time, the mobile telephones 101 and 102 are connected with the second communication and synchronize the management table T1 as shown by an arrow 314 of FIG. 15.

If the second communication is established, a device having a higher number of the management ID in the user information table of the management table T1 transmits the decrypted data to a device having a smaller number of the management ID.

In other words, the second communication control unit 208 of the mobile telephone 102 with the management ID of “2” (slave) controls the second communication unit 142 to transmit the decrypted data D2 retained in the RAM 113 to the mobile telephone 101 with the management ID of “1” (master) as shown by an arrow 315 of FIG. 15 in Step S146. On the other hand, the second communication control unit 208 of the mobile telephone 101 controls the second communication unit 142 to receive the decrypted data D2 transmitted from the mobile telephone 102 in Step S116.

The data restoration unit 205 of the mobile telephone 101 that receives the decrypted data D2 restores the application data APD from the decrypted data D1 retained in the RAM 113 and the decrypted data D2 received from the mobile telephone 102 in a method corresponding to an algorithm set in the tally algorithm of the data information table of the management table T1. At this time, the data restoration unit 205 checks the validity of the restored application data APD based on the hash value retained in the RAM 113. Accordingly, it is possible to restore application data APD with high reliability.

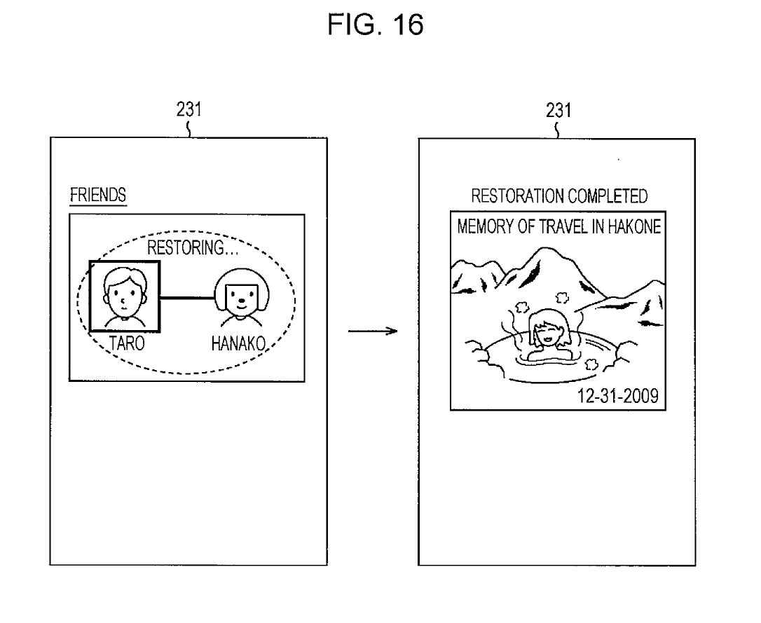

Furthermore, if the data restoration unit 205 of the mobile telephone 101 starts to restore the application data APD in Step S117, the display 231 of the mobile telephone 101 displays an image expressing that the data distributed and saved in each of the devices used by “Taro” and “Hanako” who belong to the group “friends” is restoring as shown in the left side of FIG. 16. Then, if the restoration of the application data APD is completed, the display 231 of the mobile telephone 101 displays a message “restoration completed” indicating that the restoration of the application data APD has been completed, and the restored data (image) is displayed as shown in the right side of FIG. 16.

If the restoration of the application data is completed, the second communication control unit 208 of the mobile telephone 101 controls the second communication unit 142 to transmit the restored application data APD to the mobile telephone 102 as shown by an arrow 316 of FIG. 15 in Step S118. On the other hand, the second communication control unit 208 of the mobile telephone 102 controls the second communication unit 142 to receive the application data APD transmitted from the mobile telephone 101 in Step S147.

According to the above process, the application data distributed and saved in the mobile telephones 101 and 102 is decrypted with encryption keys that each of the communication partners has, and the application data is restored from each piece of the decrypted data in communication system 100. Thus, the restoration of the application data is not possible unless the devices in which the application data is distributed and saved are brought together during the restoration of the data. Therefore, it is possible to restore distributed and saved data more safely.

Hereinabove, a configuration in which data is distributed and saved in a communication system constituted by two devices has been described, but data can be distributed and saved also in a communication system constituted by three or more devices.

Hereinbelow, a configuration in which data is distributed and saved in a communication system constituted by three or more devices will be described.

### 2. Second Embodiment

### [Other Configuration Example of Communication System]

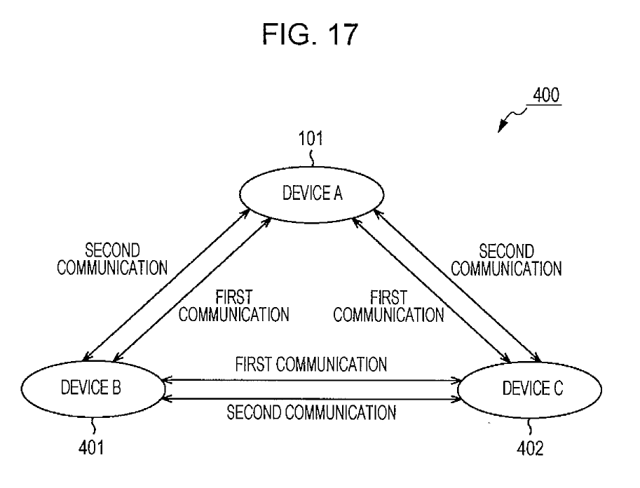

FIG. 17 is a diagram showing another configuration example of a communication system. In FIG. 17, a communication system 400 is a system that performs wireless communication between a plurality of devices to exchange data and execute applications based on the data. As shown in FIG. 17, the communication system 400 includes, for example, a device A 101, a device B 401, and a device C 402.

Furthermore, since the device A 101 in FIG. 17 is the same as the mobile telephone 101 in the communication system 100 of FIG. 1, the same reference numeral is given thereto. In addition, since the internal configuration example and functional example of the device A 101 is the same as the configuration described with reference to FIGS. 2 and 3, and the internal configuration example and functional example of the devices B 401 and C 402 which are communication partners of the device A 101 also are basically the same as the configuration of the mobile telephone 101 described with reference to FIGS. 2 and 3, description on the configurations of the devices B 401 and C 402 will not be omitted.

The devices A 101, B 401, and C 402 perform communication to one another in two methods of the first communication and the second communication described above in the communication system 400.

### [Data Saving in Communication System]

Next, the data saving in the communication system 400 will be described.

The devices A 101, B 401, and C 402 can share and save application data by performing communication with one another in the communication system 400.

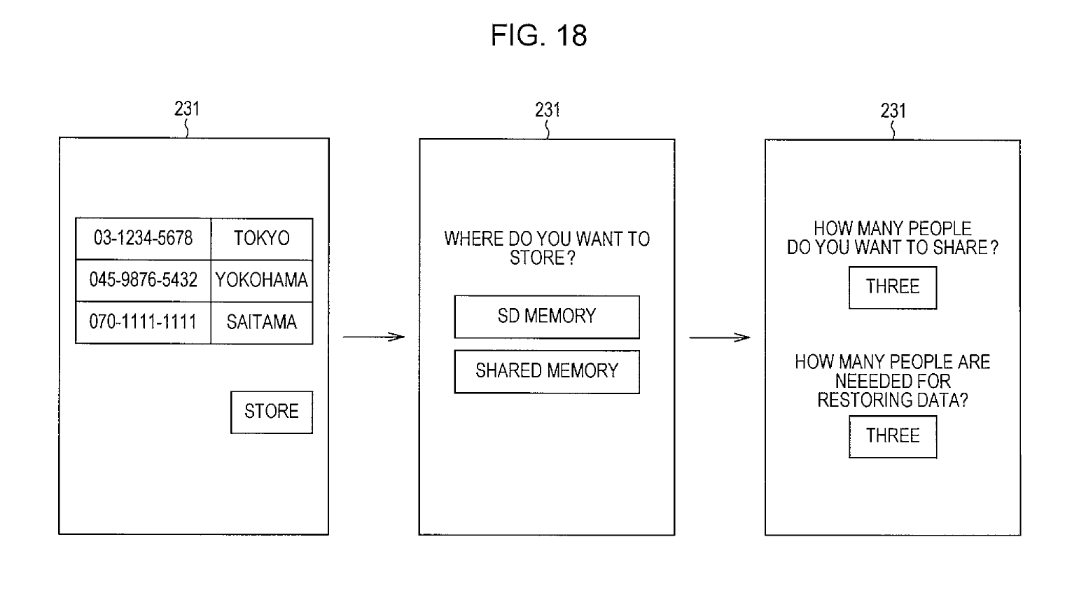

For example, it is assumed that predetermined application data is retained in the RAM 113 of the device A 101. The display 231 of the device A 101 displays an image expressed by the application data (table data) retained in the device A 101 and a “save” button as a GUI for a user to instruct the saving of the application data as shown in the left side of FIG. 18.

If the user of the device A 101 selects the “save” button from the state in the left side of FIG. 18, the display 231 of the device A 101 displays a message saying “Where do you want to save?” for asking the user about a saving place of the application data, and an “SD memory” button and a “shared memory” button for selecting a candidate of the saving place, as shown in the center of FIG. 18.

Herein, when the user of the device A 101 selects the “SD memory” button, the application data retained in the RAM 113 of the device A 101 is saved in the NVRAM 114 of the device A 101. On the other hand, when the user of the device A 101 selects the “shared memory” button, the display 231 of the device A 101 displays a message saying “How many people do you want to share with?” for allowing the user to select the number of devices to share the application data, and a message saying “How many people are needed for restoring data?” for allowing the user to select the number of devices necessary for restoring the shared and saved application data as shown in the right side of FIG. 18. In addition, below each of the messages, for example, a text box (or a drop-down list) or the like that enables the user to perform an input for the message is displayed. In FIG. 18, since each text box is input with “three”, the application data is shared with three devices, and restored by the three devices.

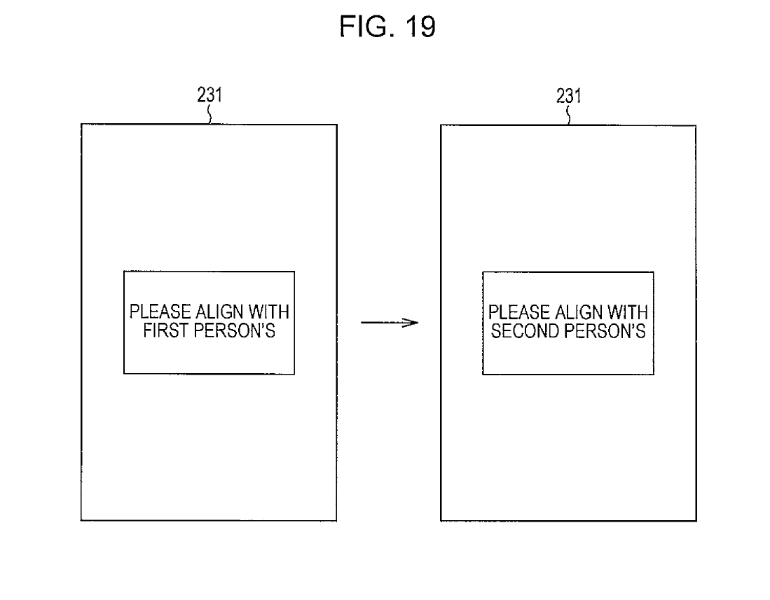

If the user inputs (determines) the number of devices to share the application data and the number of device to restore the shared application data, the display 231 of the device A 101 displays a message saying “please align with first person's” as shown in the left side of FIG. 19 to prompt the user of the device A 101 to bring the casing of the device A 101 close to or into contact with either casing of the device B 401 or the device C 402.

Then, for example, if the casing of the device A 101 is brought close to or into contact with the casing of the device B 401, a data saving process in which the devices A 101, B 401, and C 402 share and save data in the communication system 400 is executed.

### [Data Saving Process]

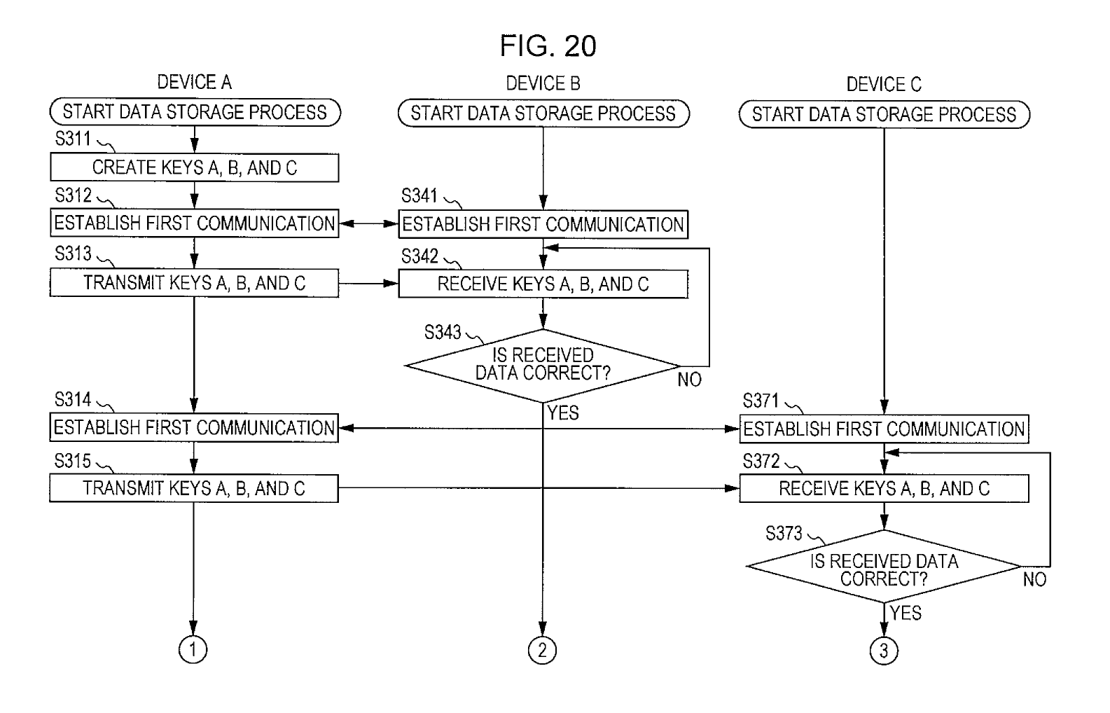

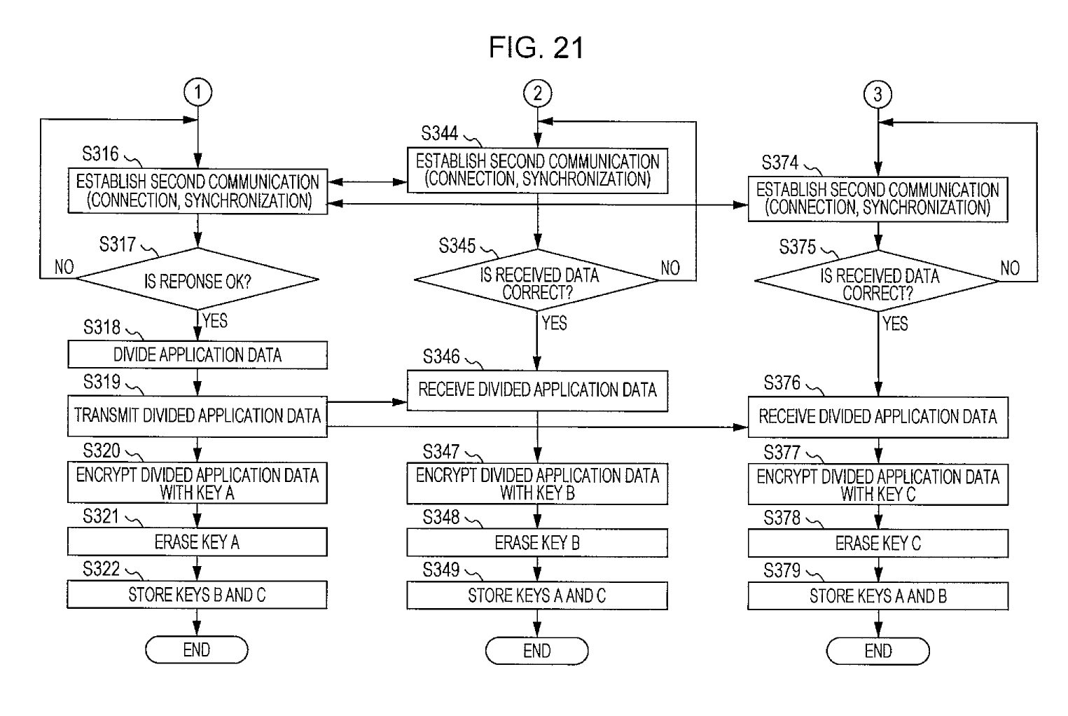

The data saving process of the devices A 101, B 401, and C 402 in the communication system 400 will be described with reference to the flowcharts of FIGS. 20 and 21.

The random number generation unit 201 of the device A 101 creates keys A, B, and C that are encryption keys used in each of the devices A 101, B 401, and C 402 by generating random numbers in Step S311. Herein, the key A is used in the device A 101, the key B in the device B 401, and the key C in the device C 402.

If the keys A, B, and C are created, the handover control unit 206 of the device A 101 controls the first communication control unit 207 to establish the first communication with the device B 401 in Step S312. On the other hand, the handover control unit 206 of the device B 401 controls the first communication control unit 207 to establish the first communication with the device A 101 in Step S341.

If the first communication is established between the device A 101 and B 401, the first communication control unit 207 of the device A 101 controls the first communication unit 141 to transmit the keys A, B, and C created in the random number generation unit 201 to the device B 401 in Step S313. On the other hand, the first communication control unit 207 of the device B 401 controls the first communication unit 141 to receive the keys A, B, and C transmitted from the device A 101 in Step S342.

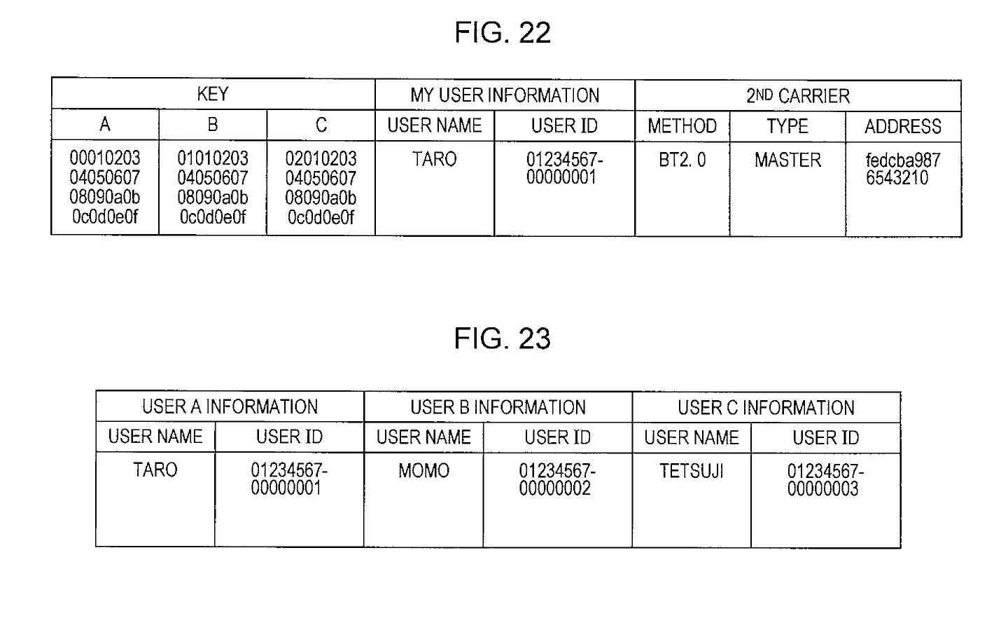

Herein, key data expressing keys transmitted from the device A 101 by the first communication will be described with reference to FIG. 22.

The key data is constituted largely by three information parts including a Key part indicating information of each transmitted key, a My User Information part indicating information of a user of a device serving as a transmission source of keys (hereinafter, simply referred to as a transmission source), and a 2nd carrier part that is information on the second communication performed between the transmission source and a device serving as a transmission destination of the keys A, B, and C (hereinafter, simply referred to as a transmission destination).

The key part is constituted by data of each transmitted key, and the key A is indicated by “000102030405060708090a0b0c0d0e0f”, the key B by “010102030405060708090a0b0c0d0e0f”, and the key C by “020102030405060708090a0b0c0d0e0f” in FIG. 22.

The My User Information part is constituted by a User Name indicating the name of the user, and a User ID specifying the user, and the User Name is set to “Taro” and the User ID to “01234567-00000001” in FIG. 22.

In addition, the 2nd carrier part is constituted by a method indicating the communication scheme (communication method) of the second communication, a device type indicating whether the transmission source of the key data is a master or a slave in the second communication, and an address that is identification information of the transmission source in the second communication. In FIG. 22, the method is set to “BT 2.0” indicating Bluetooth version 2.0, and the type to “Master” indicating to be a master, and the address to “fedcba9876543210”.

Returning to the flowchart of FIG. 20, the first communication control unit 207 of the device B 401 determines whether or not the key data of the received keys A, B, and C is correct in Step S343.

When it is determined that the key data of the received keys A, B, and C is not correct in Step S343, the device B 401 requests the device A 101 that is the transmission source for re-transmission of the keys A, B, and C, and the process returns to Step S342. In addition, the process of Steps S342 and S343 is repeated until the key data of the received keys A, B, and C is determined to be correct.

On the other hand, when it is determined that the key data of the received keys A, B, and C is correct in Step S343, the device B 401 transmits information that the key data is correct to the device A 101 that is the transmission source, and the process advances to Step S344 to be described later.

Then, if the device A 101 receives the information that the key data is correct from the device B 401 in Step S313, the display 231 of the device A 101 displays a message saying “please align with second person's” as shown in the right side of FIG. 19 prompting the user of the device A 101 to bring the casing of the device A 101 close to or into contact with the casing of the device C 402.

Then, if the casing of the device A 101 and the casing of the device C 402 come close to or into contact with each other, the handover control unit 206 of the device A 101 controls the first communication control unit 207 to establish the first communication with the device C 402 in Step S314. On the other hand, the handover control unit 206 of the device C 402 controls the first communication control unit 207 to establish the first communication with the device A 101 in Step S371.

If the first communication between the device A 101 and the device C 402 is established, the first communication control unit 207 of the device A 101 controls the first communication unit 141 to transmit the keys A, B, and C to the device C 402 in Step S315. On the other hand, the first communication control unit 207 of the device C 402 controls the first communication unit 141 to receive the keys A, B, and C transmitted from the device A 101 in Step S372.

The key data described with reference to FIG. 22 is also transmitted from the device A 101 to the device C 402 herein.

Then, the first communication control unit 207 of the device C 402 determines whether or not the received key data of the keys A, B, and C is correct in Step S373.

When it is determined that the received key data of the keys A, B, and C is not correct in Step S373, the device C 402 requests the device A 101 that is the transmission source for re-transmission of the keys A, B, and C, and the process returns to Step S372. Then, the process of Steps S372 and S373 is repeated until the received key data of the keys A, B, and C is determined to be correct.

On the other hand, when it is determined that the received key data of the keys A, B, and C is correct in Step S373, the device C 402 transmits information that the key data is correct to the device A 101 that is the transmission source, and the process advances to Step S374 to be described later.

Then, when the device A 101 receives the information that the key data is correct from the device C 402 after Step S315, the handover control unit 206 of the device A 101 controls the second communication control unit 208 to establish the second communication between the device B 401 and the device C 402 in Step S316.

On the other hand, the handover control unit 206 of the device B 401 controls the second communication control unit 208 to establish the second communication with the device A 101 in Step S344. In addition, the handover control unit 206 of the device C 402 controls the second communication control unit 208 to establish the second communication with the device A 101 in Step S374.

At this time, the devices A 101, B 401, and C 402 synchronize the management table T1 by being connected to one another with the second communication and exchanging information for synchronizing the management table T1 stored in each NVRAM 114 thereof. Furthermore, when devices A 101, B 401, and C 402 are connected to one another with the second communication in advance, the exchange of information for synchronizing the management table T1 and the synchronization of the management table T1 are performed.

First, the devices A 101, B 401, and C 402 perform exchange of user information indicating each user thereof. Specifically, the device A 101 transmits a User A Information of user information in the left side of FIG. 23 to the devices B 401 and C 402. The User A Information of the user information is constituted by a User Name of “Taro” indicating the name of the user of the device A 101, and a User ID of “01234567-00000001” specifying the user.

In addition, the device B 401 transmits a User B Information of user information in the center of FIG. 23 to the device A 101, and the device C 402 transmits a User C Information of user information in the right side of FIG. 23 to the device A 101. The User B Information of the user information is constituted by a User Name of “Momo” indicating the name of the user of the device B 401, and a User ID of “01234567-00000002” specifying the user, and the User C Information of the user information is constituted by a User Name of “Tetsuji” indicating the name of the user of the device C 402 and a User ID of “01234567-00000003” specifying the user.

If the device A 101 receives the user information from the device B 401, the device A 101 transmits the user information from the device B 401 to the device C 402, and when the device A 101 receives the user information from the device C 402, the device A 101 transmits the user information from the device C 402 to the device B 401. Accordingly, the user information on each of the users of the devices A 101, B 401, and C 402 shown in FIG. 23 is shared by each device.

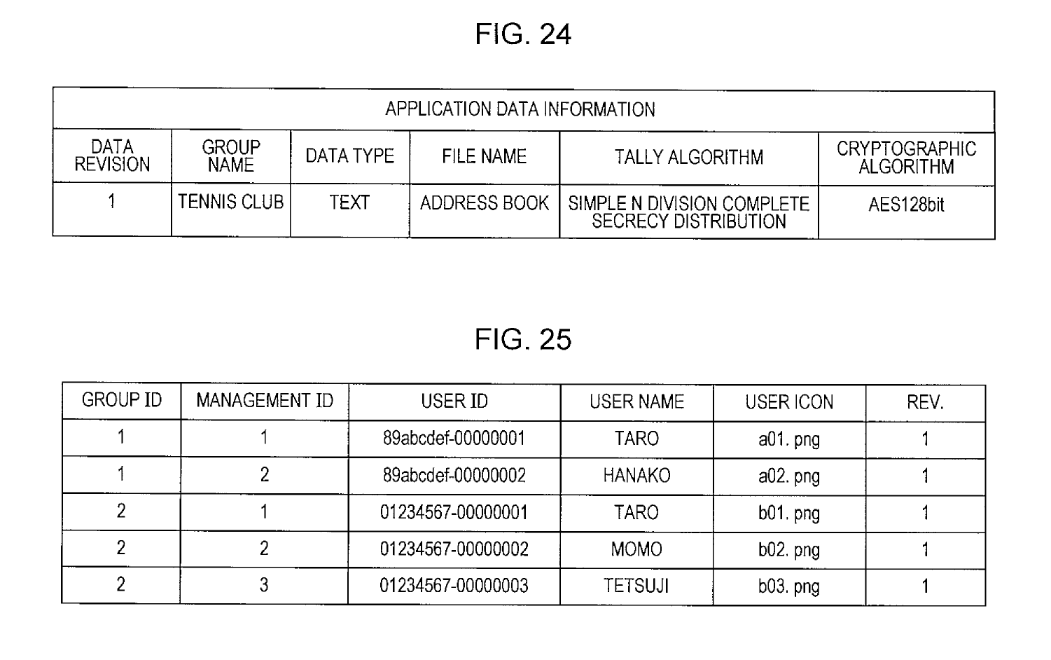

Next, the device A 101 transmits application data information regarding the application data retained in the RAM 113 and shared with and saved in the devices A 101, B 401 and C 402 to the devices B 401 and C 402. Specifically, the device A 101 transmits the application data information shown in FIG. 24 to the devices B 401 and C 402.

As shown in FIG. 24, the application data information is constituted by a Data Revision indicating the version of the application data saved in each device within the group, a Group Name that is the name of the group, a data type indicating the type of the shared application data, a file name indicating the file name of the application data as a file, a tally algorithm indicating an algorithm used for dividing the application data for sharing, and a cryptographic algorithm indicating an algorithm used for encrypting the divided application data.

In FIG. 24, the Data Revision is set to “1”, the Group Name to “tennis club”, and data type to “Text” indicating the data to be character data, and the file name to “address book”. In addition, the tally algorithm is set to “simple n divided complete secret distribution method”, and the cryptographic algorithm to “AES (Advanced Encryption Standard) 128-bit”.

As such, the application data information shown in FIG. 24 is shared by each device with the application data information transmitted from the device A 101 to the devices B 401 and C 402.

Then, the devices A 101, B 401, and C 402 synchronize the management table T1 stored in each NVRAM 114 thereof based on the user information and the application data information described above.

Specifically, the user information table of the management table T1 is synchronized based on the user information described with reference to FIG. 23.

FIG. 25 shows an example of the user information table stored in the NVRAM 114 of the device A 101.

As described above, since the device A 101 is the same as the mobile telephone 101 of the communication system 100 of FIG. 1, the user information table of FIG. 25 shows information on the devices A 101, B 401, and C 402 as three devices that belong to a group of which the Group ID is “2”, in addition to the information described with reference to FIG. 9. Specifically, for the device A 101, the management ID is set to “1”, the User ID to “01234567-00000001”, the User Name to “Taro”, the User Icon to “b01.png”, and the Rev. to “1”. For the device B 401, the management ID is set to “2”, the User ID to “01234567-00000002”, the User Name to “Momo”, the User Icon to “b02.png”, and the Rev. to “1”. In addition, for the device C 402, the management ID is set to “3”, the User ID to “01234567-00000003”, the User Name to “Tetsuji”, the User Icon to “b03.png”, and the Rev. to “1”. In this case, the device A 101 of which the management ID is “1” is set to a master in the communication system 400, and the device B 401 of which the management ID is “2” and the device C 402 of which the management ID is “3” are set to slaves in the communication system 400.

Furthermore, the user information table of the devices B 401 and C 402 includes at least information on three devices that belong to a group of which the Group ID is “2”.

The devices A 101, B 401, and C 402 can share information on the communication partners of the group to which they belong with such a user information table.

In addition, the data information table of the management table T1 is synchronized based on the above-described application data information.

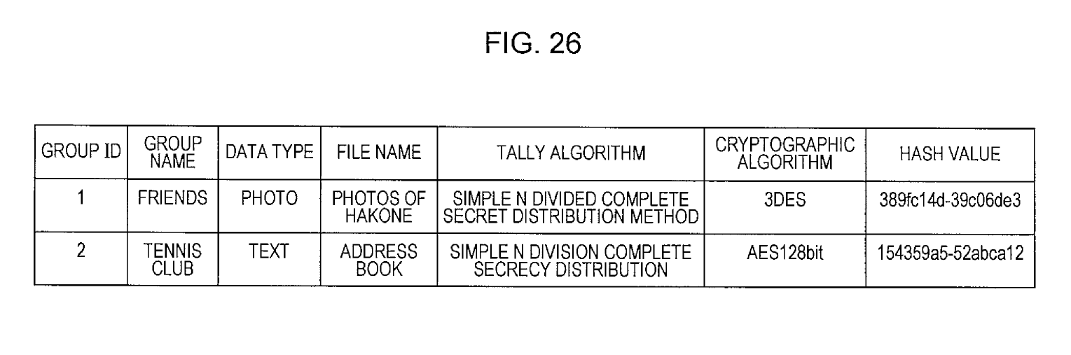

FIG. 26 shows an example of the data information table stored in the NVRAM 114 of the device A 101.

The data information table of FIG. 26 shows information on the application data shared by the devices A 101, B 401, and C 402 as three devices that belong to the group of which the Group ID is “2”, in addition to the information described with reference to FIG. 9. Specifically, the Group ID is set to “2”, the Group Name to “tennis club”, the data type to “Text” indicating that the data is character data, and the file name to “address book”. In addition, the tally algorithm is set to the “sample n divided complete secret distribution method”, the cryptographic algorithm to “AES128 bit”, and the hash value to “154359a5-52abca12”.

Furthermore, the data information table of the devices B 401 and C 402 includes at least information on the application data shared by three devices that belong to a group of which the Group ID is “2”.

The devices A 101, B 401, and C 402 can share the information on the application data divided and saved in the group with such a data information table.

Returning to the flowchart of FIG. 21, the second communication control unit 208 of the device B 401 determines whether or not the received data from the device A 101 (user information and application data information) is correct in Step S345.

When the received data is determined to be not correct in Step S345, the device B 401 requests the device A 101 for re-transmission of the data, and the process returns to Step S344. Then, the process of Steps S344 and S345 is repeated until the received data is determined to be correct.

On the other hand, when the received data is determined to be correct in Step S345, the device B 401 transmits information that the data is correct to the device A 101 that is the transmission source, and the process advances to Step S346 to be described later.

In addition, the second communication control unit 208 of the device C 402 determines whether or not the received data from the device A 101 is correct in Step S375.

When the received data is determined to be not correct in Step S375, the device C 402 requests the device A 101 for re-transmission of the data, and the process returns to Step S374. Then, the process of Steps S374 and S375 is repeated until the received data is determined to be correct.

On the other hand, when the received data is determined to be correct in Step S375, the device C 402 transmits information that the data is correct to the device A 101 that is the transmission source, and the process advances to Step S376 to be described later.

Then, the second communication control unit 208 of the device A 101 determines whether or not the responses from the devices B 401 and C 402 is OK based on the information transmitted from the devices B 401 and C 402 in Step S317.

When it is determined that the responses are not OK in Step S317, in other words, when at least either piece of information transmitted from the devices B 401 and C 402 includes content of requesting re-transmission of the data, the process returns to Step S316, and the process of Steps S316 and S317 is repeated until information that the data is correct is transmitted from each of the devices B 401 and C 402.

On the other hand, when the responses are determined to be OK in Step S317, the process advances to Step S318, and the data division unit 202 of the device A 101 divides the application data retained in the RAM 113 in a method set in the tally algorithm of the data information table of the management table T1.

For example, the data division unit 202 of the device A 101 divides the application data retained in the RAM 113 in the simple n divided complete secret distribution method.

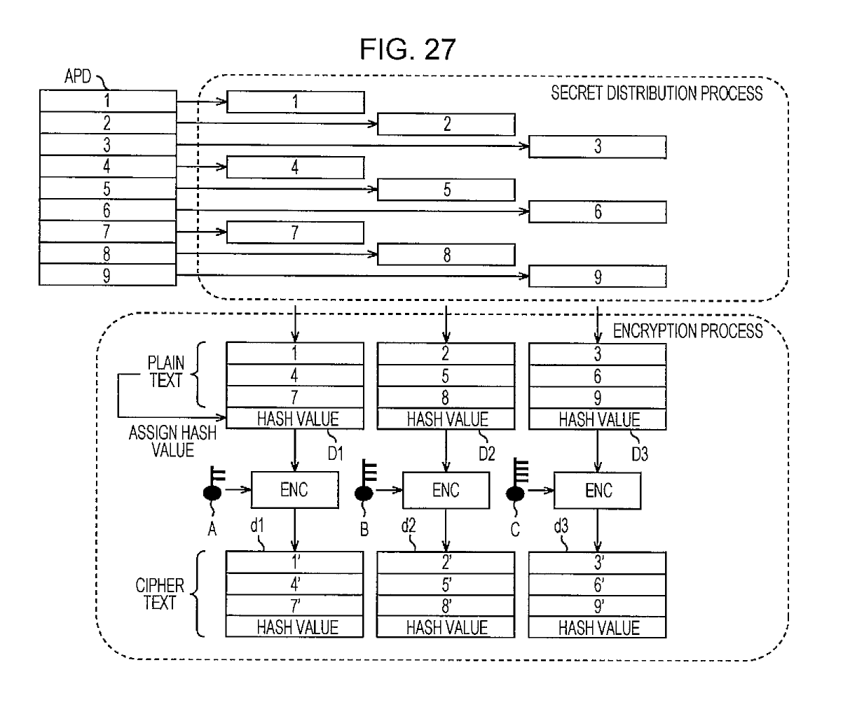

Specifically, as shown in FIG. 27, the data division unit 202 of the device A 101 divides the application data APD into data 1 to 9, and each portion of data 1, 4, and 7, data 2, 5, and 8, and data 3, 6, and 9 out of the whole data is set to one unity of divided data.

In Step S319, the second communication control unit 208 of the device A 101 controls the second communication unit 142 to transmit the application data (divided data) divided by the data division unit 202 to the devices B 401 and C 402. Specifically, the device B 401 is transmitted with divided data composed of the data 2, 5, and 8 out of the divided data described in FIG. 27, and the device C 402 is transmitted with divided data composed of the data 3, 6, and 9 out of the divided data described in FIG. 27.

Then, the second communication control unit 208 of the device B 401 controls the second communication unit 142 to receive the divided data transmitted from the device A 101 in Step S346. In addition, the second communication control unit 208 of the device C 402 controls the second communication unit 142 to receive the divided data transmitted from the device A 101 in Step S376.

The encryption unit 203 of the device A 101 which transmitted the divided data to the devices B 401 and C 402 encrypts the divided application data (divided data) with the key A in a method set in the cryptographic algorithm of the data information table of the management table T1 in Step S320. Specifically, as shown in FIG. 27, the divided data D1 (plain text) composed of the data 1, 4, and 7 is encrypted with the key A. At this time, the divided data D1 is assigned with a hash value obtained based on the divided data D1, and the data is encrypted. Encrypted data d1 (cipher text) composed of the encrypted data 1′, 4′, and 7′ is supplied to the NVRAM 114, and saved (stored) therein.

In Step S321, the encryption unit 203 of the device

A 101 erases the key A used in the encryption in Step S320.

Then, in Step S322, the random number generation unit 201 of the device A 101 supplies the NVRAM 114 with the keys B and C not used in the encryption among the keys A, B, and C created in Step S311 to have them saved (stored).

On the other hand, the encryption unit 203 of the device B 401 which received the divided data from the device A 101 encrypts the divided application data (divided data) with the key B in a method set in the cryptographic algorithm of the data information table of the management table T1 in Step S347. Specifically, as shown in FIG. 27, the divided data D2 (plain text) composed of the data 2, 5, and 8 is encrypted with the key B. At this time, the divided data D2 is assigned with a hash value obtained based on the divided data D2, and the data is encrypted. Encrypted data d2 (cipher text) composed of the encrypted data 2′, 5′, and 8′ is supplied to the NVRAM 114, and saved (stored) therein.

In Step S348, the encryption unit 203 of the device B 401 erases the key B used in the encryption in Step S347.

Then, in Step S349, the first communication control unit 207 of the device B 401 supplies the NVRAM 114 with the keys A and C not used in the encryption among the keys A, B, and C received in Step S342 to have them saved (stored).

Furthermore, the encryption unit 203 of the device C 402 which received the divided data from the device A 101 encrypts the divided application data (divided data) from the device A 101 with the key C in a method set in the cryptographic algorithm of the data information table of the management table T1 in Step S377. Specifically, as shown in FIG. 27, the divided data D3 (plain text) composed of the data 3, 6, and 9 is encrypted with the key C. At this time, the divided data D3 is assigned with a hash value obtained based on the divided data D3, and the data is encrypted. Encrypted data d3 (cipher text) composed of the encrypted data 3′, 6′, and 9′ is supplied to the NVRAM 114, and saved (stored) therein.

In Step S378, the encryption unit 203 of the device C 402 erases the key C used in the encryption in Step S377.

Then, in Step S379, the first communication control unit 207 of the device C 402 supplies the NVRAM 114 with the keys A and B not used in the encryption among the keys A, B, and C received in Step S372 to have them saved (stored).

According to the above process, in the communication system 400, the application data retained in the device A 101 is divided, and the divided application data is distributed to the devices A 101, B 401, and C 402, and then encrypted and saved in each device. In addition the encryption keys used in each of the devices are erased after the encryption. Accordingly, when the application data shared in the communication system 400 is to be restored, it is not possible to decrypt the encrypted data and restore the original application data from the decrypted data unless all the devices A 101, B 401, and C 402 are brought together. In addition, in the communication system 400, the devices A 101, B 401, and C 402 are designed to exchange data by performing handover from the first communication to the second communication. Therefore, it is possible to save data more conveniently and safely.

Furthermore, in the above description, since the complete secret distribution method is used as the tally algorithm when the application data is to be divided, it is not possible to restore the original application data unless all the devices A 101, B 401, and C 402 are brought together. In other words, when any one of the devices A 101, B 401, and C 402 is broken or the like, the restoration of the original application data becomes completely not possible.

Thus, as the tally algorithm, k-out-of-n threshold value secret distribution method may be used which enables the restoration of the original application data by bringing a few pieces of divided data. Herein, n indicates the number of divided data pieces to be distributed, and k indicates the number of divided data pieces necessary for the data restoration. n and k can be determined by a user in the input screen displayed in the display 231 shown in the right side of FIG. 18.

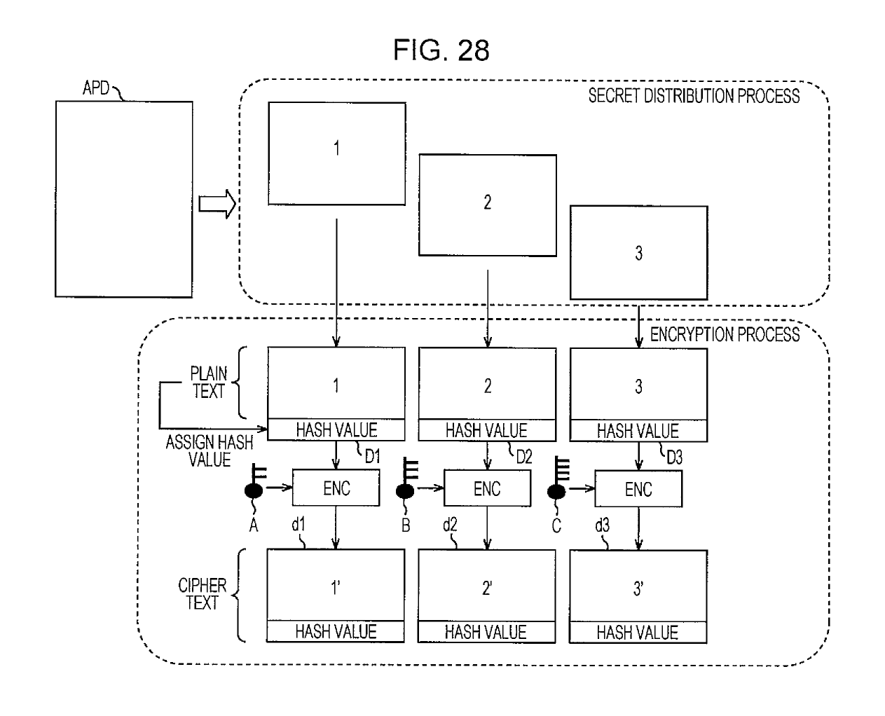

FIG. 28 is a diagram illustrating a secret distribution process and an encryption process used in the 2-out-of-3 threshold value secret distribution method.

In FIG. 28, the application data APD is divided into three pieces of data 1 to 3 in the 2-out-of-3 threshold value secret distribution method. Divided data D1 (plain text) that is the data 1 is assigned with a hash value and encrypted with the key A, and encrypted data d1 (cipher text) that is encrypted data 1′ is saved in the device A 101. Divided data D2 (plain text) that is the data 2 is assigned with a hash value and encrypted with the key B, and encrypted data d2 (cipher text) that is encrypted data 2′ is saved in the device B 401. In addition, divided data D3 (plain text) that is the data 3 is assigned with a hash value and encrypted with the key C, and encrypted data d3 (cipher text) that is encrypted data 3′ is saved in the device C 402.

Since the divided data D1 to D3 in FIG. 28 is divided in the 2-out-of-3 threshold value secret distribution method, when the original application data is to be restored, just two divided data out of three divided data can be used for restoring the original application data. In addition, in the communication system 400, since the devices A 101, B 401, and C 402 save all the encryption keys except for one that each of the devices uses, even when any one of the devices A 101, B 401, and C 402 is broken or the like, the original application data can be restored. Therefore, it is possible to save data with higher availability and safety.

Furthermore, in the above description, the application data is assumed to be divided by the device A 101, but a configuration may be possible that the device A 101 transmits the application data to the devices B 401 and C 402 before dividing the application data, and then each of the devices A 101, B 401, and C 402 divide the application data and encrypt only corresponding divided data.

In the above, a process in which the application data is shared and saved in the communication system 400, but in the below, a process in which the saved application data is restored will be described.

### [Restoration of Data in Communication System]

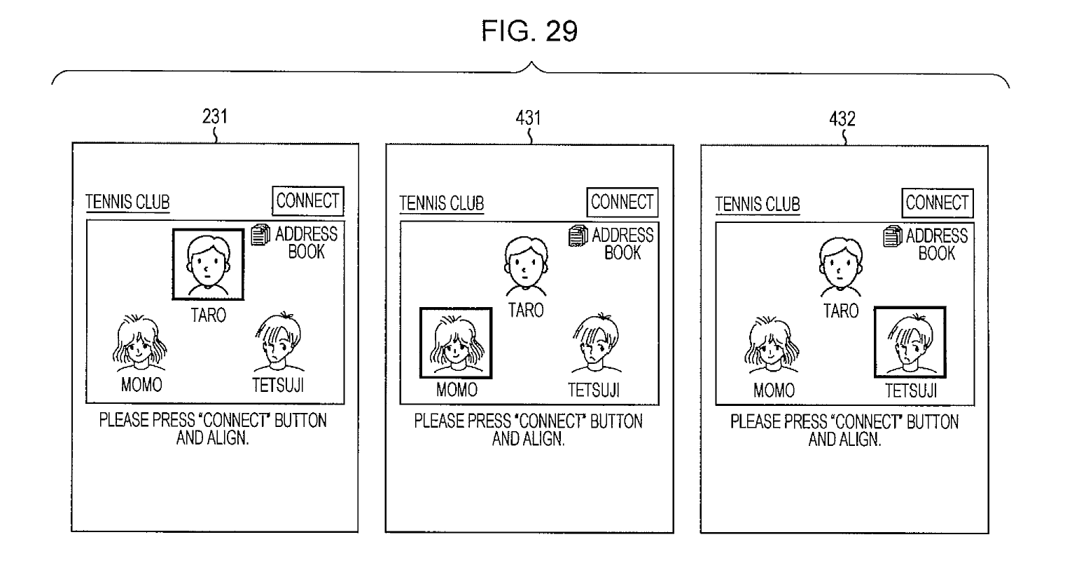

When the application data is distributed and saved in each of the NVRAM 114 of the devices A 101, B 401, and C 402 by the above-described data saving process, if a user performs a predetermined operation, the display 231 of the device A 101, the display 431 of the device B 401, and the display 432 of the device C 402 display the group name “tennis club” to which the devices belong, icons indicating the users (“Taro”, “Momo”, and “Tetsuji”) who use the devices that belong to the group, the file name “address book” of the shared application data as a file, and the “connect” button used by the users to instruct the connection (start of communication) for the restoration of the application data as a GUI, for example as shown in FIG. 29, based on the user information tables and the data information table of the management table stored in each of the devices A 101, B 401, and C 402.

Furthermore, in FIG. 29, the icons indicating the users of the devices are shown with frames emphasizing the icons. In other words, the display 231 of the device A 101 displays the frame around the icon indicating “Taro” who is the user of the device A 101, the display 431 of the device B 401 displays the frame around the icon indicating “Momo” who is the user of the device B 401, and the display 432 of the device C 402 displays the frame around the icon indicating “Tetsuji” who is the user of the device C 402.

Furthermore, below the icons of the users of the devices, a message saying “please press “connect” button and align devices” prompting the users to bring the casings of their devices close to or into contact with the casing of the other device.

Then, if the user of each of the devices A 101, B 401, and C 402 selects the “connect” button from the state shown in FIG. 29, and for example, the casing of the device A 101 and the casing of the device B 401 are brought close to or into contact with each other, a data restoration process in which the devices A 101, B 401, and C 402 restore the distributed and saved data in the communication system 400 is executed.

### [Data Restoration Process]

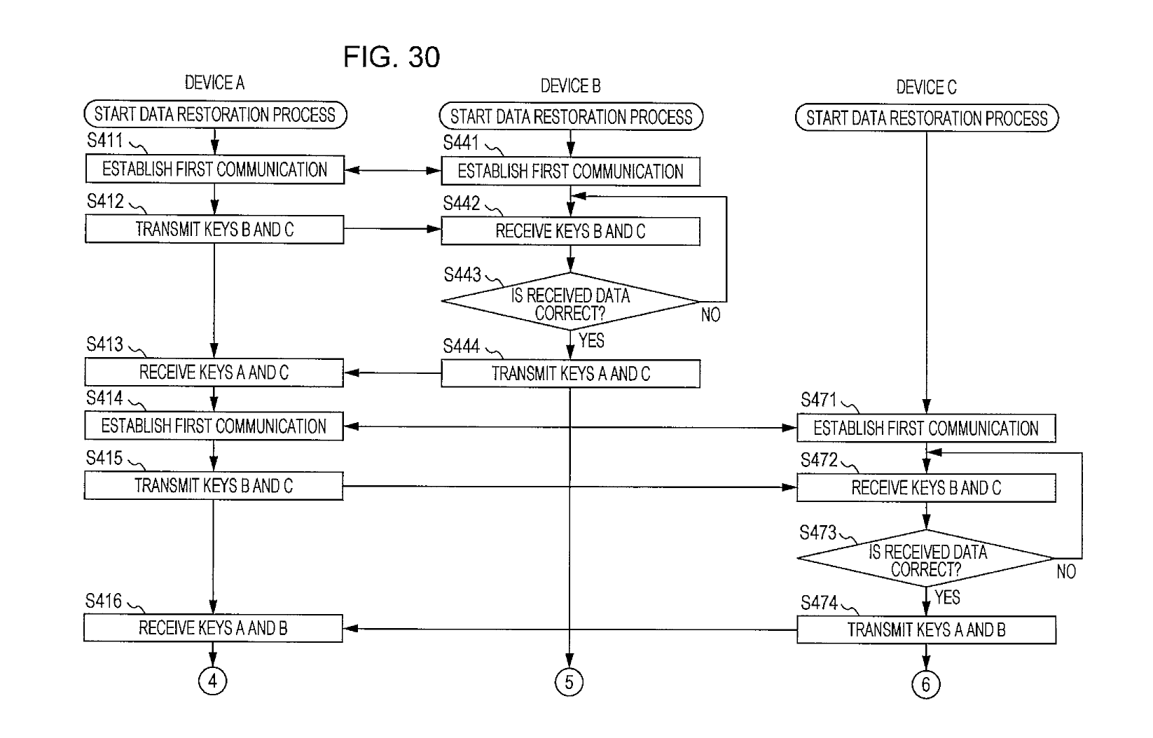

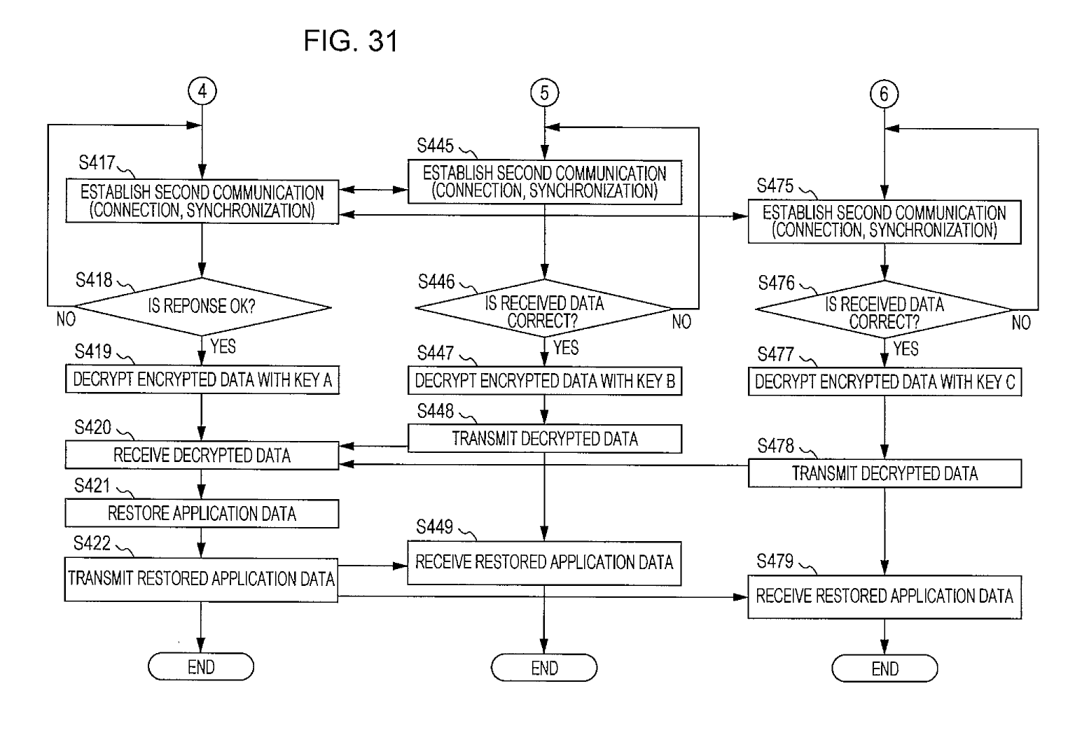

A data restoration process of the devices A 101, B 401, and C 402 in the communication system 400 will be described with reference to the flowcharts of FIGS. 30 and 31.

The handover control unit 206 of the device A 101 controls the first communication control unit 207 to establish the first communication with the device B 401 in Step S411. On the other hand, the handover control unit 206 of the device B 401 controls the first communication control unit 207 to establish the first communication with the device A 101 in Step S441.

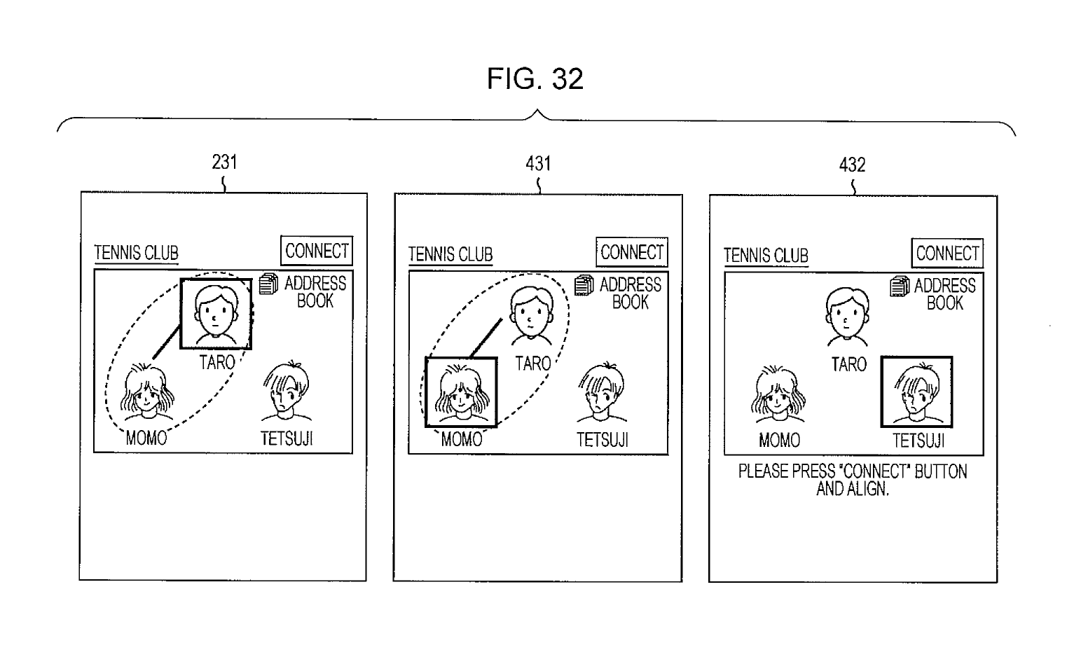

If the first communication is established, the display 231 of the device A 101 displays a line indicating that the first communication is established between the icon indicating “Taro” who is the user of the device A 101 and the icon indicating “Momo” who is the user of the device B 401 as shown in FIG. 32. In the same manner, the display 431 of the device B 401 displays a line indicating that the first communication is established between the icon indicating “Momo” who is the user of the device B 401 and the icon indicating “Taro” who is the user of the device A 101.

The first communication control unit 207 of the device A 101 controls the first communication unit 141 to transmit the keys B and C stored in the NVRAM 114 to the device B 401 in Step S412. On the other hand, the first communication control unit 207 of the device B 401 controls the first communication unit 141 to receive the keys B and C transmitted from the device A 101 in Step S442.

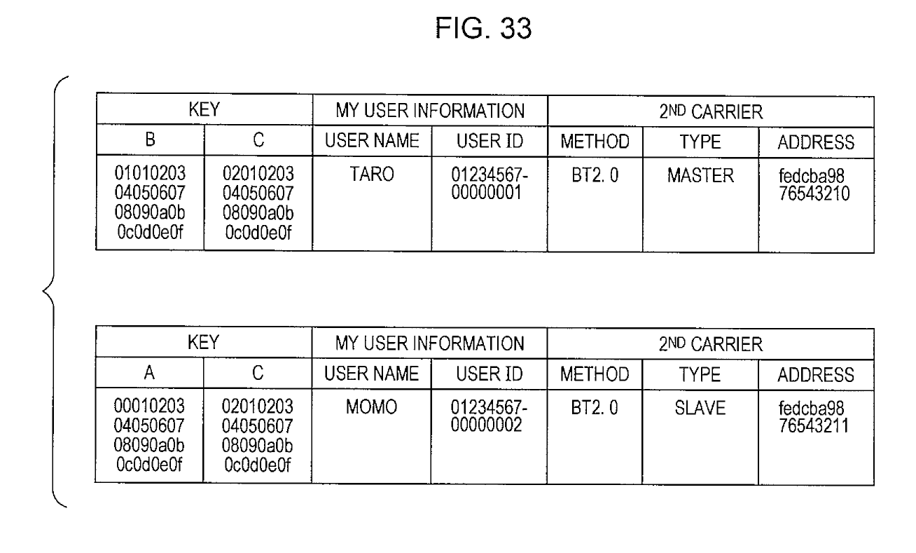

Herein, key data indicating the keys transmitted from the device A 101 to the device B 401 is configured as shown in the upper side of FIG. 33. The key data basically has the same configuration as the key data described with reference to FIG. 22, but in the Key part, data of the key A erased after encryption in the device A 101 does not exist.

Returning to the flowchart of FIG. 30, the first communication control unit 207 of the device B 401 determines whether or not the key data of the received keys B and C is correct in Step S443.

When the key data of the received keys B and C is determined to be not correct in Step S443, the device B 401 requests the device A 101 that is the transmission source for re-transmission of the keys B and C, and the process returns to Step S442. Then, the process of Steps S442 and S443 is repeated until the key data of the received keys B and C is determined to be correct.

On the other hand, when the key data of the received keys B and C is determined to be correct in Step S443, the device B 401 transmits information that the key data is correct to the device A 101 that is the transmission source, and the process advances to Step S444.

The first communication control unit 207 of the device B 401 controls the first communication unit 141 to transmit the keys A and C stored in the NVRAM 114 to the device A 101 in Step S444. On the other hand, the first communication control unit 207 of the device A 101 controls the first communication unit 141 to receive the keys A and C transmitted from the device B 401 in Step S413.

Herein, the key data indicating the keys transmitted from the device B 401 to the device A 101 is configured as shown in the lower side of FIG. 33. In the My User Information part of the key data, the User Name is set to “Momo”, and the User ID to “01234567-00000002”, and in the 2nd carrier part, the type is set to “Slave” indicating being a slave, and in the key part, data of the key B erased after the encryption in the device B 401 does not exist.

If the keys are exchanged between the devices A 101 and B 401, and then the casing of the device A 101 and the casing of the device C 402 are brought close to or into contact with each other, the handover control unit 206 of the device A 101 controls the first communication control unit 207 to establish the first communication between the device C 402 in Step S414. On the other hand, the handover control unit 206 of the device C 402 controls the first communication control unit 207 to establish the first communication between the device A 101 in Step S471.

The first communication control unit 207 of the device A 101 controls the first communication unit 141 to transmit the keys B and C stored in the NVRAM 114 to the device C 402 in Step S415. On the other hand, the first communication control unit 207 of the device C 402 controls the first communication unit 141 to receive the keys B and C transmitted from the device A 101 in Step S472.

The first communication control unit 207 of the device C 402 determines whether or not key data of the received keys B and C is correct in Step S473.

When the key data of the received keys B and C is determined to be not correct in Step S473, the device C 402 requests the device A 101 that is the transmission source for re-transmission of the keys B and C, and the process returns to Step S472. Then, the process of Steps S472 and S473 is repeated until the key data of the received keys B and C is determined to be correct.

On the other hand, when the key data of the received keys B and C is determined to be correct in Step S473, the device C 402 transmits information that the key data is correct to the device A 101 that is the transmission source, and the process advances to Step S474.

The first communication control unit 207 of the device C 402 controls the first communication unit 141 to transmit the keys A and B stored in the NVRAM 114 to the device A 101 in Step S474. On the other hand, the first communication control unit 207 of the device A 101 controls the first communication unit 141 to receive the keys A and B transmitted from the device C 402 in Step S416.

After the device A 101 received the keys A and B from the device C 402 in Step S416, the handover control unit 206 of the device A 101 controls the second communication control unit 208 to establish the second communication between the device B 401 and between the device C 402 in Step S417.

The handover control unit 206 of the device B 401 controls the second communication control unit 208 to establish the second communication between the device A 101 in Step S445. In addition, the handover control unit 206 of the device C 402 controls the second communication control unit 208 to establish the second communication between the device A 101 in Step S475.

At this time, the device A 101 and the device B 401, and the device C 402 synchronize the management table T1 by being connected with the second communication to each other, and exchanging information (user information and application data information) for synchronizing the management table T1 stored in the NVRAM 114 of each device. Furthermore, when the device A 101 and the device B 401, and the device C 402 are connected to each other in advance with the second communication, the exchange of the information for synchronizing the management table T1 and the synchronization of the management table T1 are performed. Particularly, in the data restoration process, it is possible to check the version of the application data to be restored with the Data Revision of the application data information.

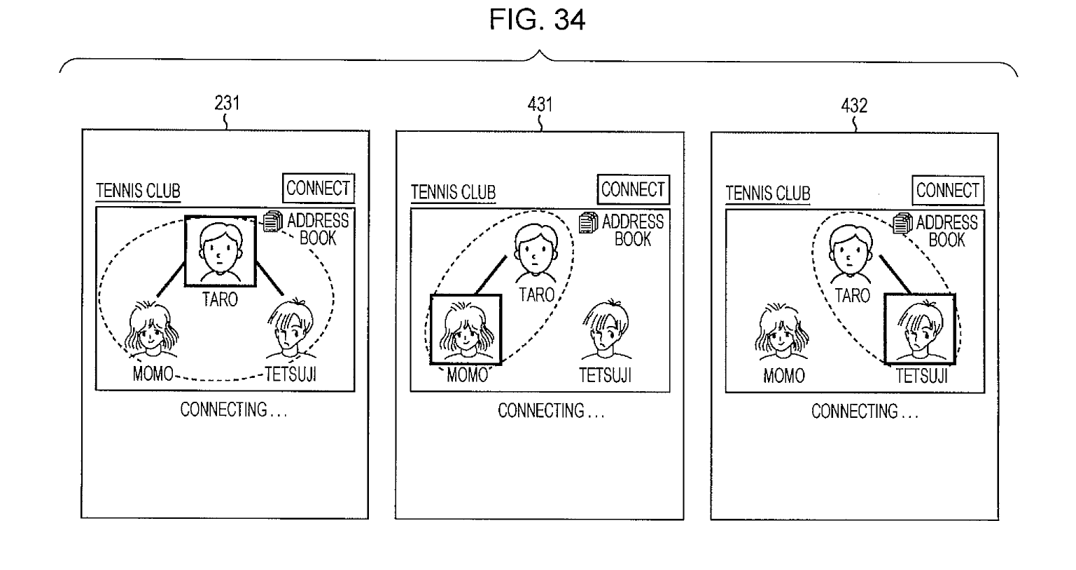

In addition, while the device A 101 and the device B 401, and the device C 402 establish the second communication to each other, the display 231 of the device A 101, the display 431 of the device B 401, and the display 432 of the device C 402 display lines indicating that the second communication is to be established and a message saying “connecting . . . ” between the icons of each user as shown in FIG. 34.

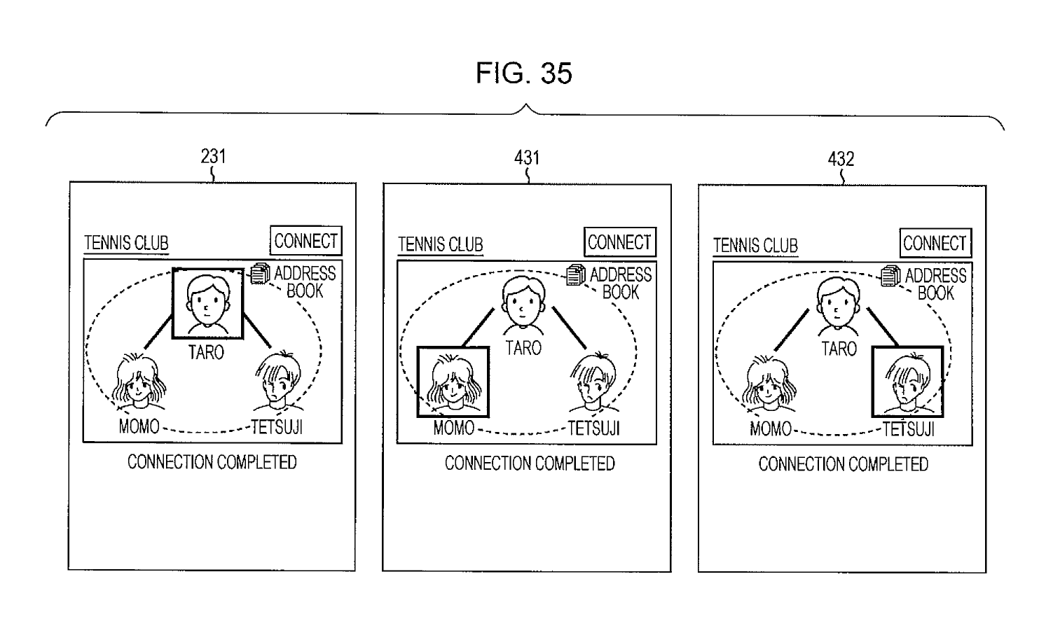

Then, the device A 101 and the device B 401, and the device C 402 complete the establishment of the second communication between each other, the display 231 of the device A 101, the display 431 of the device B 401, and the display 432 of the device C 402 display lines between the icons of “Taro” and “Momo”, and between the icons of “Taro” and “Tetsuji” indicating that the second communication has been established and a message saying “connection completed” as shown in FIG. 35.

Returning to the flowchart of FIG. 31, the second communication control unit 208 of the device B 401 determines whether or not the received data (user information and application data information) is correct in Step S446.

When the received data is determined to be not correct in Step S446, the device B 401 request the device A 101 for re-transmission of the data, and the process returns to Step S445. Then, the process of Steps S445 and S446 is repeated until the received data is determined to be correct.

On the other hand, when received data is determined to be correct in Step S446, the device B 401 transmits information that the data is correct to the device A 101 that is the transmission source, and the process advances to Step S447 to be described later.

In addition, the second communication control unit 208 of the device C 402 determines whether or not the received data is correct in Step S476.

When the received data is determined to be not correct in Step S476, the device C 402 request the device A 101 for re-transmission of the data, and the process returns to Step S475. Then, the process of Steps S475 and S476 is repeated until the received data is determined to be correct.

On the other hand, when received data is determined to be correct in Step S476, the device C 402 transmits information that the data is correct to the device A 101 that is the transmission source, and the process advances to Step S477 to be described later.

Then, the second communication control unit 208 of the device A 101 determines whether or not the responses from the device B 401 and C 402 are OK based on the information transmitted from the device B 401 and C 402 in Step S418.

When the responses are determined to be not OK in Step S418, in other words, when at least either piece of information transmitted from the devices B 401 and C 402 includes content of requesting re-transmission of the data, the process returns to Step S417, and the process of Steps S417 and S418 is repeated until information that the data is correct is transmitted from each of the devices B 401 and C 402.

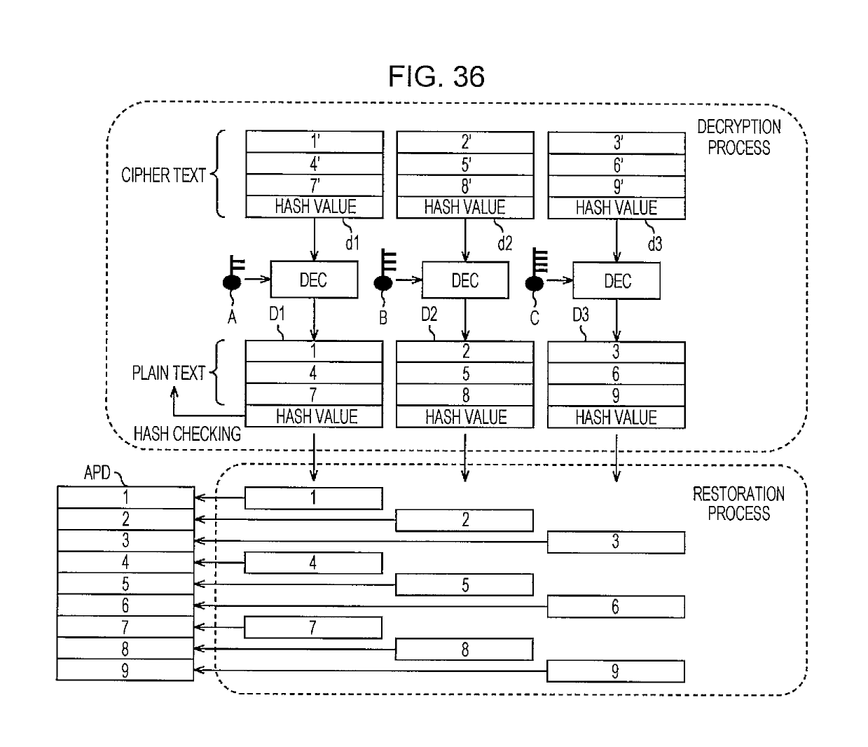

On the other hand, when the responses are determined to be OK in Step S418, the process advances to Step S419, and the decryption unit 204 of the device A 101 decrypts the encrypted data stored in the NVRAM 114 with the key A out of the encryption keys transmitted (supplied) from the devices B 401 and C 402 in a method set in the cryptographic algorithm of the data information table of the management table T1. Specifically, the encrypted data d1 stored in the NVRAM 114 of the device A 101 is decrypted with the key A as shown in FIG. 36. Decrypted data D1 (plain text) once decrypted is supplied to the RAM 113 and stored therein. At this time, the decryption unit 204 checks the validity of the decrypted data D1 based on the hash value assigned to the encrypted data d1. Accordingly, it is possible to obtain the decrypted data D1 with high reliability.

In addition, the decryption unit 204 of the device B 401 decrypts the encrypted data stored in the NVRAM 114 with the key B out of the encryption keys transmitted (supplied) from the devices A 101 and C 402 in the method set in the cryptographic algorithm of the data information table of the management table T1 in Step S447. Specifically, the encrypted data d2 stored in the NVRAM 114 of the device B 401 is decrypted with the key B as shown in FIG. 36. Decrypted data D2 (plain text) once decrypted is supplied to the RAM 113 and stored therein. At this time, the decryption unit 204 checks the validity of the decrypted data D2 based on the hash value assigned to the encrypted data d2. Accordingly, it is possible to obtain the decrypted data D2 with high reliability.

The second communication control unit 208 of the device B 401 controls the second communication unit 142 to transmit the decrypted data D2 stored in the RAM 113 to the device A 101 in Step S448.

Then, the decryption unit 204 of the device C 402 decrypts the encrypted data stored in the NVRAM 114 with the key C out of the encryption keys transmitted (supplied) from the devices A 101 and B 401 in the method set in the cryptographic algorithm of the data information table of the management table T1 in Step S477. Specifically, the encrypted data d3 stored in the NVRAM 114 of the device C 402 is decrypted with the key C as shown in FIG. 36. Decrypted data D3 (plain text) once decrypted is supplied to the RAM 113 and stored therein. At this time, the decryption unit 204 checks the validity of the decrypted data D3 based on the hash value assigned to the encrypted data d3. Accordingly, it is possible to obtain the decrypted data D3 with high reliability.

The second communication control unit 208 of the device C 402 controls the second communication unit 142 to transmit the decrypted data D3 stored in the RAM 113 to the device A 101 in Step S478.

The second communication control unit 208 of the device A 101 controls the second communication unit 142 to receive the decrypted data D2 transmitted from the device B 401 and the decrypted data D3 transmitted from the device C 402 in Step S420, and the process advances to Step S421.

The data restoration unit 205 of the device A 101 restores the application data APD from the decrypted data D1 stored in the RAM 113, the decrypted data D2 transmitted from the device B 401, and the decrypted data D3 transmitted from the device C 402 in a method corresponding to an algorithm (for example, a method corresponding to the simple n divided complete secret distribution method) set in the tally algorithm of the data information table of the management table T1 in Step S421.

Specifically, the data restoration unit 205 of the device A 101 divides the decrypted data D1 into data 1, 4, and 7, the decrypted data D2 into data 2, 5, and 8, and the decrypted data D3 into data 3, 6, and 9 to restore the application data APD from the divided data 1 to 9 as shown in FIG. 36. At this time, the data restoration unit 205 checks the validity of the restored application data APD based on the hash values set in the data information table of the management table T1. Accordingly, it is possible to restore the application data APD with high reliability.

If the restoration of the data is completed, the second communication control unit 208 of the device A 101 controls the second communication unit 142 to transmit the restored application data APD to the devices B 401 and C 402 in Step S422.

The second communication control unit 208 of the device B 401 controls the second communication unit 142 to receive the application data APD transmitted from the device A 101 in Step S449. In addition, the second communication control unit 208 of the device C 402 controls the second communication unit 142 to receive the application data APD transmitted from the device A 101 in Step S479.

According to the above process, the application data distributed to and saved in the devices A 101, B 401, and C 402 is decrypted with the encryption keys other than one that each of the devices uses, and the application data is restored from each piece of the decrypted data in the communication system 400. As such, the restoration of the application data is not possible unless the devices in which the application data is distributed and shared are brought together during the restoration of the data. Therefore, it is possible to restore the saved data more safely.

In addition, when the original application data is to be restored in the case where the application data distributed and saved in the devices A 101, B 401, and C 402 is distributed in the 2-out-of-3 threshold value secret distribution method described with reference to FIG. 28, if there are two pieces of the divided data out of three pieces of the divided data, the original application data can be restored. Furthermore, in the communication system 400, since the devices A 101, B 401, and C 402 save all the encryption keys except for one that each of the devices uses, even when any one of the devices A 101, B 401, and C 402 is broken or the like, the original application data can be restored. Therefore, it is possible to restore distributed and saved data with higher availability and safety.

In the above description, the device A 101 is set to a master and the devices B 401 and C 402 to slaves in the communication system 400, but any devices may be set to a master and a slave.

A series of processes described above can be executed by hardware and software. When the series of processes is executed by software, a program constituting the software is installed from a network or a recording medium.

Such a recording medium is constituted not only by a magnetic disk (including a flexible disk), an optical disc (including a CD-ROM and a DVD), a magneto-optical disc (including an MD), or the removable medium 131 composed of a semiconductor memory on which a program is recorded, being separated from the device main body, for example, as shown in FIG. 2, but also by the ROM 112 to which a program is recorded, hard disk included in the storage unit 123, or the like which is provided in a state of being incorporated with the device main body in advance.

Furthermore, in the present specification, steps describing a program recorded in a recording medium include processes performed in a time series following the disclosed order and also include processes performed individually or in parallel, without being necessarily processed in a time series.

In addition, in the present specification, a system refers to a whole apparatus constituted by a plurality of devices (units).

Furthermore, in the above, the configuration described as one device may be configured to be a plurality of separate devices. On the other hand, a configuration described as a plurality of devices above may be configured to be one device. In addition, a configuration other than the above-described configuration of each device may be added thereto. Furthermore, one part of a configuration of a device may be included in a configuration of another device if the configuration and operations as a whole system are practically the same. In other words, an embodiment of the present technology is not limited to the above-described embodiment, and can be variously modified in a scope not departing from the gist of the technology.

The present disclosure contains subject matter related to that disclosed in Japanese Priority Patent Application JP 2010-143399 filed in the Japan Patent Office on Jun. 24, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device which shares data with one or more communication partners, comprising:
a creation unit which creates its own encryption key that the device uses for itself and encryption keys that the communication partners use;
a first communication unit which transmits all the encryption keys created by the creation unit to the communication partners with the first communication;
a division unit which divides the data;
an encryption unit which encrypts its own data that the device is to save for itself among the data divided by the division unit with its own encryption key;
a second communication unit which transmits other data that the communication partners are to save among the data divided by the division unit to the communication partners with the second communication; and
a storage unit which stores its own data encrypted by the encryption unit and the other encryption keys.

2. The information processing device according to claim 1, wherein the encryption unit erases its own encryption key used in the encryption after its own data is encrypted.

3. The information processing device according to claim 2,
wherein the first communication unit receives its own encryption key that is stored by the communication partners and transmitted through the first communication, and
the second communication unit receives the other data saved by the communication partners and transmitted through the second communication, further comprising:
a decryption unit which decrypts its own data stored in the storage unit with its own encryption key received by the first communication unit; and
a restoration unit which restores the data from its own data decrypted by the decryption unit and the other data received by the second communication unit.

4. The information processing device according to claim 2,
wherein the storage unit further stores management information regarding the device itself and the communication partners sharing the data, and based on the management information,
the division unit divides the data,
the second communication unit transmits the other data to the communication partners, and
the encryption unit encrypts its own data.

5. An information processing method of an information processing device sharing data with one or more communication partners, comprising:
creating its own encryption key that the device uses for itself and encryption keys that the communication partners use;
first communication controlling for controlling transmission of all the encryption keys created by the creation process to the communication partners with the first communication;
dividing the data;
encrypting its own data that the device is to save for itself among the data divided by the division process with its own encryption key;
second communication controlling for controlling transmission of the other data that the communication partners are to save among the data divided by the division process to the communication partners with the second communication; and
storing its own data encrypted by the encryption process and the other encryption keys.

6. A program which causes a computer to execute a process of an information processing device sharing data with one or more communication partners, the processing comprising:
creating its own encryption key that the device uses for itself and encryption keys that the communication partners use;
controlling first communication to transmit all the encryption keys created by the creation process to the communication partners with the first communication;
dividing the data;
encrypting its own data that the device is to save for itself among the data divided by the division process with its own encryption key;
controlling second communication to transmit other data that the communication partners are to save among the data divided by the division process to the communication partners with the second communication; and
controlling storage of its own data encrypted by the encryption process and the other encryption keys.

7. An information processing device sharing data with a communication partner, comprising:
a first communication unit which receives its own encryption key that is an encryption key that the device uses for itself and the other encryption key that is an encryption key that the communication partner uses which are transmitted from the communication partner with first communication;
a second communication unit which receives own data that is data that the device is to save out of the data divided in the communication partner and transmitted from the communication partner with second communication;
an encryption unit which encrypts its own data received by the second communication unit with its own encryption key received by the first communication unit; and
a storage unit which stores its own data encrypted by the encryption unit and the other encryption key.

8. The information processing device according to claim 7, wherein the encryption unit erases its own encryption key used in the encryption after its own data is encrypted.

9. The information processing device according to claim 7,
wherein the first communication unit receives its own encryption key stored by the communication partner and transmitted with the first communication,
which further comprises a decryption unit which decrypts its own data stored in the storage unit with its own encryption key received by the first communication unit,
wherein the second communication unit transmits its own data decrypted by the decryption unit to the communication partner with the second communication.

10. The information processing device according to claim 7,
wherein the storage unit further stores management information regarding the device itself and the communication partner sharing the data, and based on the management information,
wherein the second communication unit receives its own data transmitted from the communication partner, and
the encryption unit encrypts its own data.

11. An information processing method of an information processing device sharing data with a communication partner, comprising:
first-communicating to receive its own encryption key that is an encryption key that the device uses for itself and the other encryption key that is an encryption key that the communication partner uses which are transmitted from the communication partner with the first communication;
second-communicating to receive own data that is data that the device is to save out of the data divided in the communication partner and transmitted from the communication partner with the second communication;
encrypting its own data received in the second communication process with its own encryption key received in the first communication process; and
storing its own data encrypted in the encryption process and the other encryption key.

12. A program which causes a computer to execute a process of an information processing device sharing data with a communication partner, the processing comprising:
first communication controlling for controlling a reception of its own encryption key that is an encryption key that the device uses for itself and the other encryption key that is an encryption key that the communication partner uses which are transmitted from the communication partner with the first communication;
second communication controlling for controlling a reception of own data that is data that the device is to save out of the data divided by the communication partner and transmitted with the second communication;
encrypting its own data received in the second communication control process with its own encryption key received in the first communication control process; and
controlling storage of its own data encrypted in the encryption process and the other encryption key.

13. An information processing system including a first information processing device and one or more second information processing devices,
wherein the first information processing device includes a creation unit which creates a first encryption key that is an encryption key that the first information processing device uses and a second encryption key that is an encryption key that the second information device uses; a first communication unit which transmits all the encryption keys created by the creation unit to the second information processing device with first communication; a division unit which divides data shared in the first information processing device and the second information processing device; a first encryption unit which encrypts first data that is data that the first information processing device is to save among the data divided by the division unit with the first encryption key; a second communication unit which transmits second data that is data that the second information processing device is to save among the data divided by the division unit to the communication partner with second communication; and a first storage unit which stores the first data encrypted by the first encryption unit and the second encryption key, and
the second information processing device includes a third communication unit which receives the first encryption key and the second encryption key transmitted from the first information processing device with the first communication; a fourth communication unit which receives the second data transmitted from the first information processing device with the second communication; a second encryption unit which encrypts the second data received by the fourth communication unit with the second encryption key received by the third communication unit; and a second storage unit which stores the second data encrypted by the second encryption unit and the first encryption key.

14. An information processing device sharing data with another information processing device, comprising:
a division unit which divides the data into a plurality of pieces;
a creation unit which creates a plurality of encryption keys for encrypting the plurality of pieces of data divided by the division unit;
a first communication unit which transmits at least two encryption keys out of the plurality of encryption keys created by the creation unit with first communication;
an encryption unit which encrypts one piece of data out of the data divided by the division unit with a first encryption key out of the encryption keys transmitted by the first communication unit;
a second communication unit which transmits other data that is data saved in the other information processing device among the data divided by the division unit to the other information processing device with second communication; and
a storage unit which stores the data encrypted by the encryption unit and an encryption key other than the first encryption key out of the encryption keys transmitted to the other information processing device.

15. An information processing method of an information processing device sharing data with another information processing device, comprising:
dividing the data into a plurality of pieces;
creating a plurality of encryption keys for encrypting the plurality of pieces of data divided in the division process;
first-communicating which transmits at least two encryption keys out of the plurality of encryption keys created in the creation process to the other information processing device with the first communication;
encrypting one piece of data out of the data divided in the division process with a first encryption key out of the encryption keys transmitted in the first communication process;
second-communicating which transmits other data that is data saved in the other information processing device among the data divided in the division process to the other information processing device with the second communication; and
storing the data encrypted in the encryption process and an encryption key other than the first encryption key out of the encryption keys transmitted to the other information processing device.

16. An information processing device sharing data with another information processing device, comprising:
a first communication unit which receives at least two encryption keys transmitted from the other information processing device with first communication;
a second communication unit which receives own data that is data that the device is to save for itself out of the data divided in and transmitted from the other information processing device with second communication;
an encryption unit which encrypts its own data received by the second communication unit with a first encryption key out of the encryption keys received by the first communication unit; and
a storage unit which stores its own data encrypted by the encryption unit and an encryption key other than the first encryption key out of the encryption keys transmitted from the other information processing device.

17. An information processing system including a first information processing device and a second information processing device,
wherein the first information processing device includes a division unit which divides the data into a plurality of pieces; a creation unit which creates a plurality of encryption keys for encrypting the plurality of pieces of data divided by the division unit; a first communication unit which transmits at least two encryption keys out of the plurality of encryption keys created by the creation unit to the second information processing device with first communication; a first encryption unit which encrypts first data out of the data divided by the division unit with a first encryption key out of the encryption keys transmitted by the first communication unit; a second communication unit which transmits second data that is data saved in the second information processing device out of the data divided by the division unit to the second information processing device with second communication; and a storage unit which stores the first data encrypted by the first encryption unit and an encryption key other than the first encryption key out of the encryption keys transmitted to the second information processing device, and
the second information processing device includes a third communication unit which receives at least the two encryption keys transmitted from the first information processing device with the first communication; a fourth communication unit which receives the second data transmitted from the first information processing device with the second communication; a second encryption unit which encrypts the second data received by the fourth communication unit with a second encryption key out of the encryption keys received by the third communication unit; and a storage unit which stores the second data encrypted by the second encryption unit and an encryption key other than the second encryption key out of the encryption keys transmitted from the first information processing device.
